(19) United States
(12) Patent Application Publication
(10) Pub. No.: US 2025/0111193 A1
(43) Pub. Date: Apr. 3, 2025

(54) Knowledge-Driven Recommendation System for Conversation - Ontology and Taxonomy Binding for Recommendation System

(71) Applicant: Forum Systems, Inc., Needham, MA (US)

(72) Inventors: Rizwan Mallal, Wellesley, MA (US); Mamoon Yunus, Newton, MA (US)

(21) Appl. No.: 18/904,551

(22) Filed: Oct. 2, 2024

Related U.S. Application Data
(60) Provisional application No. 63/587,502, filed on Oct. 3, 2023.

(51) Int. Cl. G06N 3/042; G06N 5/022

(52) U.S. Cl. CPC G06N 3/042; G06N 5/022

(57) ABSTRACT

A knowledge-driven recommendation system comprises a processor and a memory with computer code instructions. The executed code instructions cause the system to receive a user query, extract a topic from the query, and submit the topic and query to a neural network. The instructions may further cause the system to return, from the neural network, a collection of taxonomy and ontology pairs, and use the pairs to select information that expands on the query and topic. The taxonomy and ontology pairs are the closest matched pairs from a knowledge graph. The closest matched pairs are retrieved when the input taxonomy topic semantically matches closest to a taxonomy topic from the custom neural network, the input ontology semantically matches closest to an ontology from the custom neural network, and the taxonomy topic from the custom neural network matches closest to one of the entities in the ontology of the neural network.

### RELATED APPLICATION

This application claims the benefit of U.S. Provisional Application No. 63/587,502, filed on Oct. 3, 2023. The entire teachings of the above application are incorporated herein by reference.

### BACKGROUND

Today, billions of computers and phones are connected via a heterogeneous network that is often referred to as the World Wide Web (WWW) or the Internet. On this Internet, billions of users access consumer applications or business applications for day-to-day operations. As users traverse through this ever-expanding digital landscape, it becomes imperative to understand the nuanced shifts that have transpired in human-computer interaction, specifically in data retrieval and management.

Once a realm dominated by arcane techniques like Structured Query Language (SQL) queries, the world has gradually moved towards a more human-centric paradigm where conversational interaction with Generative AI forms the crux of information retrieval. This background will delve into the evolution of these trends, from the esoteric command lines of yesteryear to the natural language dialogues of today.

In the early days of the Internet, the process of data retrieval and management was largely a specialized skill. The need to access and manipulate databases was catered to by SQL, a domain-specific language used to manage relational databases. SQL represented a significant leap forward in terms of capability but also erected barriers between the data and the user. SQL queries, composed of meticulously arranged logical operators, clauses, and conditions, were like incantations that unlocked treasures of data. However, mastery over these incantations was largely limited to those with technical expertise.

As the Internet matured and user-friendly graphical interfaces became more prevalent, there were various attempts to simplify data retrieval and interaction processes. Graphical User Interfaces (GUIs) for databases started making inroads. Applications like Microsoft Access sought to put the power of databases into the hands of end-users. However, GUI-based systems had their limitations. They were often confined to specific use-cases and had a learning curve of their own. Moreover, the functionality offered was often limited compared to what SQL could achieve through command-line inputs. Therefore, despite strides in accessibility, there remained a chasm between the everyday user and the omnipotent database.

The emergence of Web 2.0 and Application Programming Interfaces (APIs) brought about a sea change. Platforms like Google and Facebook offered APIs that allowed developers to fetch data in more seamless manners, abstracting away the underlying SQL complexities. But, once again, these conveniences were largely for developers. The average user was still distanced from direct interaction with the data, relying instead on predetermined queries and functionalities that developers had incorporated into applications.

Fast forward to the advent of generative AI. Generative AI refers to a subset of artificial intelligence models designed to generate new data that mimics the structure and characteristics of the data it was trained on. These models can create a wide range of outputs, from text and images to music and code, based on the input or prompt provided. The goal is to produce data that is coherent, contextually relevant, and often indistinguishable from data generated by humans. and we see an unprecedented shift in the paradigm. Models like OpenAI's GPT-4 are not merely programmed to perform tasks; they are trained to understand and generate human-like text based on vast amounts of data. Generative AI encompasses a wide array of models designed to create content, from text and images to audio and beyond. Within this exciting landscape, Large Language Models (LLMs) like OpenAI's GPT-4 stand as a notable advancement. These LLMs specialize in understanding and generating human-like text, functioning as an epitome of how far generative technologies have come in achieving nuanced, context-aware interactions.

The implications for data retrieval and interaction are profound. Rather than issuing specific SQL commands or navigating a labyrinthine GUI, users can simply ask the system questions in natural language, much like asking a librarian for information. “Show me sales figures for the last quarter,” one might say, or, “How many new users signed up for our service in August?” The generative AI can comprehend these questions, translate them into the appropriate queries or actions, and then articulate the results back in natural, easily understood language.

The above example represents one of the use cases of human-centric interaction. It involves a user having a dialogue or meaningful conversation with a LLM on the content of a specific set of documents. In the realm of generative AI and information retrieval, the concept of providing a document or a set of documents to chat with as context is generally known as “Conversational Contextual Querying” or “Context-Aware Information Retrieval.”

The migration from arcane SQL queries to natural language dialogue (“dialogue”) with generative AI represents more than a technological feat; it signifies the democratization of information. What was once the province of a technologically adept few is now accessible to anyone who can pose a question. This is an epochal shift, akin to the transition from scrolls in locked monasteries to mass-printed books.

### SUMMARY

While Large Language Models (LLMs) like GPT-4 excel in “Conversational Contextual Querying,” offering intelligent and contextually relevant responses to user queries based on a specific set of documents, they do have limitations when it comes to recommending new or related topics for discussion.

This constraint arises because these LLMs do not have access to an exhaustive knowledge base of documents, nor do they understand the hierarchical structure or taxonomy that organizes these documents into related topics and subtopics.

In essence, even though an LLM can generate answers that are pertinent to the user's query and the given set of documents, its capability to suggest additional relevant topics is limited. This is due to the model's lack of comprehensive domain knowledge, organized in a hierarchical fashion, which could otherwise guide it in making informed recommendations. The model's understanding of document taxonomy and related topics is constrained to the particular subset of documents that the user has provided as context.

Therefore, while LLMs are adept at generating relevant and coherent responses based on the information they've been given, they cannot fully extend their recommendations beyond that scope due to the absence of a complete, hierarchically organized knowledge base.

The techniques described herein provide a novel approach to recommending topics during a “Conversational Contextual Querying” session between a user and an LLM. According to these techniques, an AI enabled application representing the user (“Recommendation System”) is introduced which communicates with an LLM and acts as proxy between the user query and the LLM. The Recommendation System is the application that navigates the Knowledge Graph in novel ways to recommend new topics and related source documents based on LLM's user query or LLM's response. The Recommendation System uses techniques such as a generic query, semantic search, ontology, taxonomy, and link hopping within the knowledge graph to recommend new topics.

As the new topics are recommended, a fresh set of documents are fetched related to those topics which then serve as content for further conversational dialogue or queries with the LLM. When the LLM again responds with a relevant answer, the Recommendation system can again take that response and explore the knowledge graph for a fresh set of recommended topics. This continuous feedback process provides immense benefits to a user.

The interaction can be thought of as dynamic dialogue rather than a simple question- and-answer session. This dynamic dialogue leads to the following benefits:
Knowledge Enhancement: For the user, where the objective may include not only solving a particular problem, but also expanding the user's knowledge through recommended topics or follow-up discussions.
Interactive Learning: It leads to interactive learning by writing follow-up questions based on recommended topics. The user is more engaged in an interactive form of learning, a “guided discovery”, which is more effective than passive consumption.
Adaptability: It allows the user to frame questions for more effective answers to the LLM.
Contextual Depth: A back-and-forth dialogue allows for exploration that goes beyond surface-level information.
Enhanced performance: By leveraging a recommendation system, a user whole knowledge base of source documents doesn't need to be shared with the LLM, but only pertinent documents that are related to the topic of interest.

In one aspect, the invention may be a knowledge-driven recommendation system, comprising a processor and a memory with computer code instructions stored thereon. The memory may be operatively coupled to the processor such that, when executed by the processor, the computer code instructions cause the recommendation system to receive a query submitted by a user, extract a topic from the query, and submit the query and the topic to a custom neural network. The computer code instructions may further cause the recommendation system to return, from the custom neural network, a collection of taxonomy and ontology pairs and use the taxonomy and ontology pairs to select information that expands on the query and the topic.

The topic may be extracted from the query by sending the query to an external large language model (LLM) and requesting that the LLM produce a topic based on the query. The topic may be extracted from the query by extracting nouns from the query and using a public knowledge graph to find a common parent that can be identified as a topic for the nouns. The custom neural network may be trained on high-quality data that was curated by a human. The taxonomy and ontology pairs may be the closest matched pairs in an associated knowledge graph. The custom neural network may retrieve the closest matched pairs when (i) the input taxonomy topic semantically matches closest to a taxonomy topic from the custom neural network, (ii) the input ontology semantically matches closest to an ontology from the custom neural network, and (iii) the taxonomy topic from the custom neural network matches closest to one of the entities in the ontology of the custom neural network.

The computer code instructions may further cause the recommendation system to perform a relevance check of the topic against a taxonomy threshold to determine that sufficient relevance exists. The computer code instructions may further cause the recommendation system to select a most relevant topic in a taxonomy and select an ontology that is bound to the most relevant topic. The computer code instructions may further cause the recommendation system to take the most relevant topic and retrieve a parent taxonomy topic and grandparent taxonomy topic and designate the parent taxonomy topic and the grandparent taxonomy topic as recommended topics. The computer code instructions may further cause the recommendation system to perform a two-hop retrieval of taxonomy topics.

In another aspect, the invention may be a method of recommending new topics and related source documents, comprising receiving a query submitted by a user, extract a topic from the query, submitting the query and the topic to a custom neural network, and returning, from the custom neural network, a collection of taxonomy and ontology pairs. The method may further comprise using the taxonomy and ontology pairs to select information that expands on the query and the topic.

The method may further comprise extracting the topic from the query by sending the query to an external large language model (LLM) and requesting that the LLM produce a topic based on the query. The method may further comprise extracting the topic from the query by extracting nouns from the query and using a public knowledge graph to find a common parent that can be identified as a topic for the nouns. The method may further comprise training the custom neural network using on high-quality data that was curated by a human.

The method may further comprise retrieving, by the custom neural network, the closest matched pairs when (i) the input taxonomy topic semantically matches closest to a taxonomy topic from the custom neural network, (ii) the input ontology semantically matches closest to a ontology from the custom neural network, and (iii) the taxonomy topic from the custom neural network matches closest to one of the entities in the ontology of the custom neural network. The method may further comprise performing a relevance check of the topic against a taxonomy threshold to determine that sufficient relevance exists.

The method may further comprise, if sufficient relevance exists, selecting a most relevant topic in a taxonomy and select an ontology that is bound to the most relevant topic. The method may further comprise taking the most relevant topic and retrieving a parent taxonomy topic and grandparent taxonomy topic and designating the parent taxonomy topic and the grandparent taxonomy topic as recommended topics. The method may further comprise performing a two-hop retrieval of taxonomy topics.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example recommendation system deployed within an enterprise, mediating conversation between users and LLMs (private or public).

FIG. 1B is a block diagram of an example recommendation system deployed in the cloud, mediating conversation between users and LLMs (private or public).

FIG. 1C is a block diagram of a node that may be used to implement the recommended techniques described herein.

FIG. 2 is a flow chart of a sequence of design time steps used to develop a knowledge graph based on source content with Human-in-the-Loop validation.

FIG. 3A is a block diagram illustrating an Ontology at the atomic level and various terms used in the industry to describe Ontology attributes.

FIG. 3B is a block diagram that illustrates the binding between ontologies and taxonomies consumed at design time to build a knowledge driven recommendation system for conversation.

FIG. 4 is a block diagram of components of an example recommendation system that are needed for it to be fully functional.

FIG. 5A is a flow chart of a overall sequence of steps that may be used to enhance the “Conversational Contextual Querying” based on request-driven recommendation system.

FIG. 5A0 is a flow chart of a overall sequence of steps based on “topic”+“query” combined that may be used to enhance the “Conversational Contextual Querying” based on request-driven recommendation system.

FIG. 5A1 is a flow chart of a sequence of steps based on “query” submission on a request-driven recommendation system using taxonomy to ontology navigation.

FIG. 5A2 is a flow chart of a sequence of steps based on “query” submission on a request-driven recommendation system using ontology to taxonomy navigation.

FIG. 5A3 is a flow chart of a sequence of steps based on “topic” submission on a request-driven recommendation system using taxonomy to ontology navigation.

FIG. 5B is a flow chart of a sequence of steps that may be used to enhance the “Conversational Contextual Querying” based on a response driven topic/document recommendation system.

FIG. 5B1 is a flow chart of a sequence of detailed steps taken on a response driven topic/document recommendation system using ontology to taxonomy navigation.

FIG. 6 shows a flow diagram associated with an example according to an embodiment.

FIG. 7A and FIG. 7B show an illustrative implementation of a similarity match technique according to an embodiment.

FIG. 8A and FIG. 8B show an illustrative implementation of an obfuscation slider technique according to an embodiment.

FIG. 9A and FIG. 9B show an illustrative implementation of a pipeline technique according to an embodiment.

FIG. 10 illustrates three primary tenants of the described embodiments.

### DETAILED DESCRIPTION

A description of example embodiments follows.

Reference will now be made to the drawings in which aspects of the techniques are given numerical designations and in which the techniques will be discussed so as to enable one skilled in the art to make use of the techniques. It is to be understood that the following description presents examples of the principles of the relevant techniques and should not be viewed as narrowing the claims which follow.

Aspects of the techniques described herein are deployed in a network for information retrieval using “Conversational Contextual Querying” methodology using e.g., well-known concepts such as Knowledge Base, Knowledge Graph, Taxonomy, Ontology and finally an LLM which is based on a Generative AI model.

### Terminology

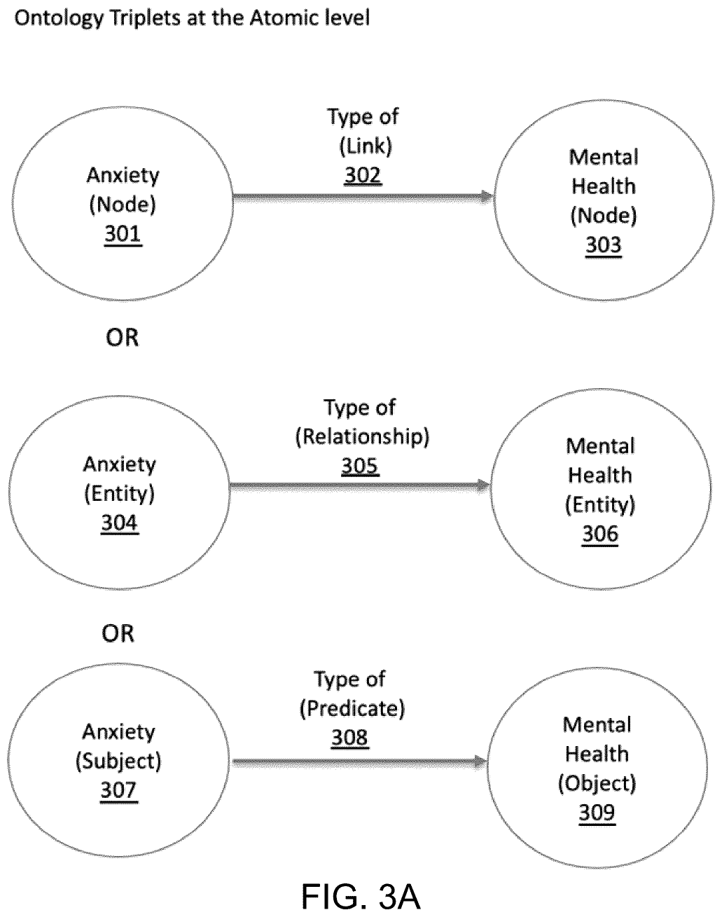

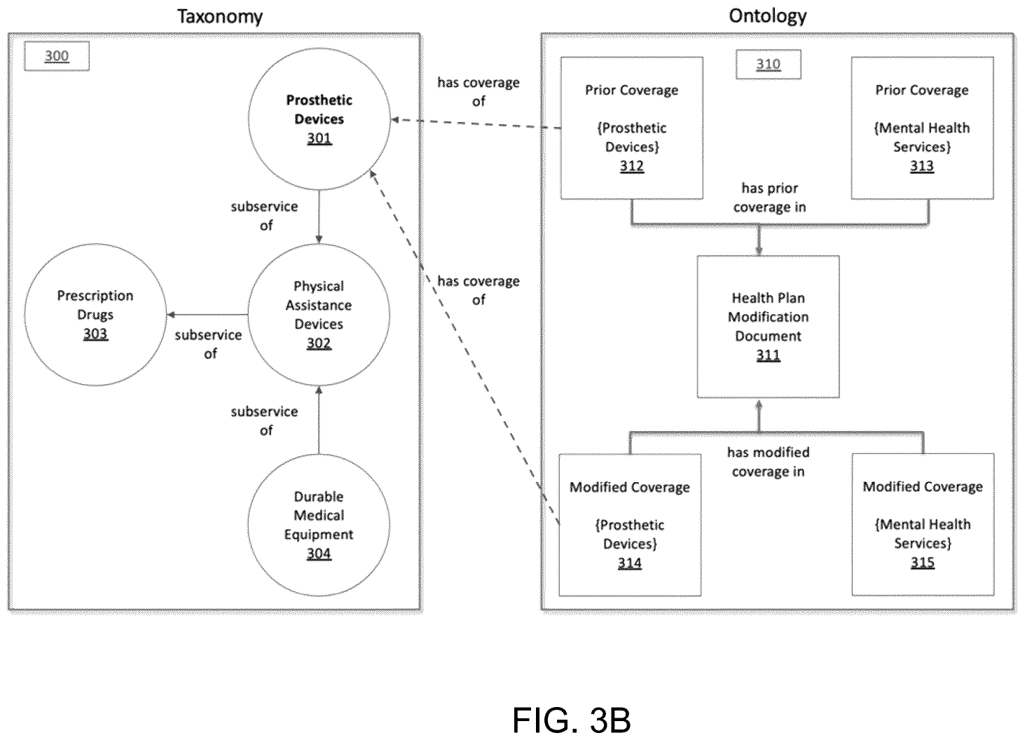

A knowledge graph is a structured representation of information and knowledge in the form of a graph. It can be derived either from unstructured content such as documents or structured content such as spreadsheets or databases. It consists of nodes (real-world entities or concepts) connected by edges (relationships or associations). Knowledge graphs are used to capture data relationships and convey their meaning, which enriches the data's meaning and utility by adding a layer of semantics, allowing software agents to reason about it. Knowledge graphs drive intelligence into data, making it smarter, and give AI the context it needs to be more explainable, accurate, and repeatable. FIG. 3B is one such example of a knowledge graph.

Knowledge graphs are being used in various industries to increase efficiency and unlock new opportunities. Here are some examples of knowledge graphs being used in industry:
1. AI/Machine Learning: Knowledge graphs are used in machine learning to improve the accuracy of predictions and recommendations by providing context and relationships between entities.
2. E-commerce: eBay's knowledge graph relates products to real-world entities, defining the identity of a product and why it might be valuable to a buyer.
3. Manufacturing: Knowledge graphs are used in the manufacturing industry to provide insights into the performance of different systems and processes, improve asset management, equipment maintenance, factory floor management & optimization, and industrial safety.
4. Building data networks: Knowledge graphs are used to build data networks and break data silos to advance AI and digital twinning.
5. Intelligent content and package reuse: Knowledge graphs are used to provide responsive and contextually aware content.
6. Healthcare: Knowledge graphs are used in healthcare to improve patient outcomes by providing a holistic view of patient data.
7. Financial services: Knowledge graphs are used in financial services to improve fraud detection and risk management.
8. Energy: Knowledge graphs are used in the energy industry to optimize energy consumption and reduce carbon emissions.
9. Transportation: Knowledge graphs are used in the transportation industry to optimize routes, reduce fuel consumption, and improve safety.

A knowledge graph is composed of a taxonomy and an ontology. Taxonomy and ontology are both used to organize information, but they differ in their approach and level of complexity. Below are the main differences between taxonomy and ontology.

### Taxonomy:

Identifies hierarchical relationships within a category.
Formalizes the hierarchical relationships among concepts and specifies the term to be used to refer to each.
Prescribes structure and terminology.
Is defined and static.
Provides the first “sorting” of content in an organization.
Relates classes using only “is_a” relationships.

### Ontology:

Identifies and distinguishes concepts and their relationships.
Describes content and relationships.
Deals in classes and subclasses.
Is more sophisticated than taxonomy.
Reveals dynamic connections between concepts.
Uses a more expressive set of pre-defined relationships such as “part_of” and “develops_from”.
Is a formal logical system that models the thinking about how a domain influences maps, models, rules, representations, and required operations.

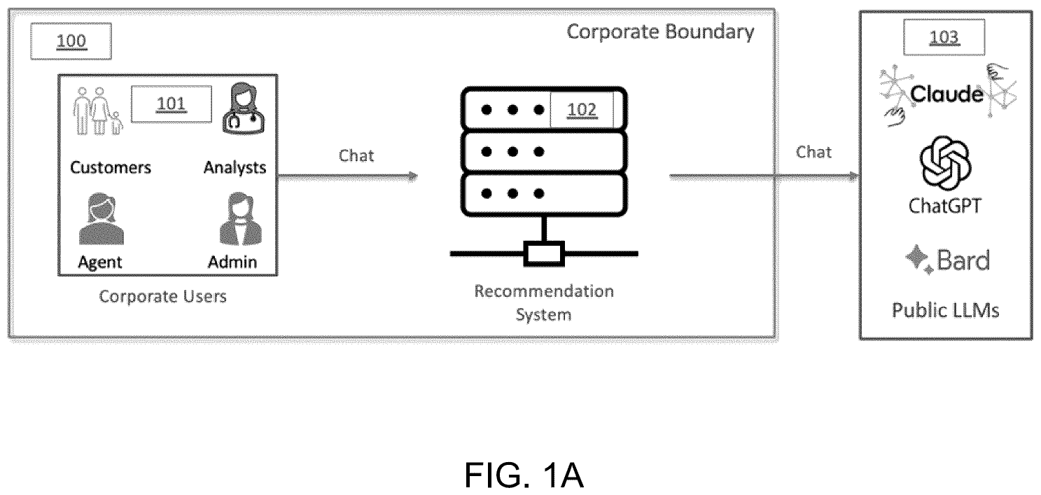

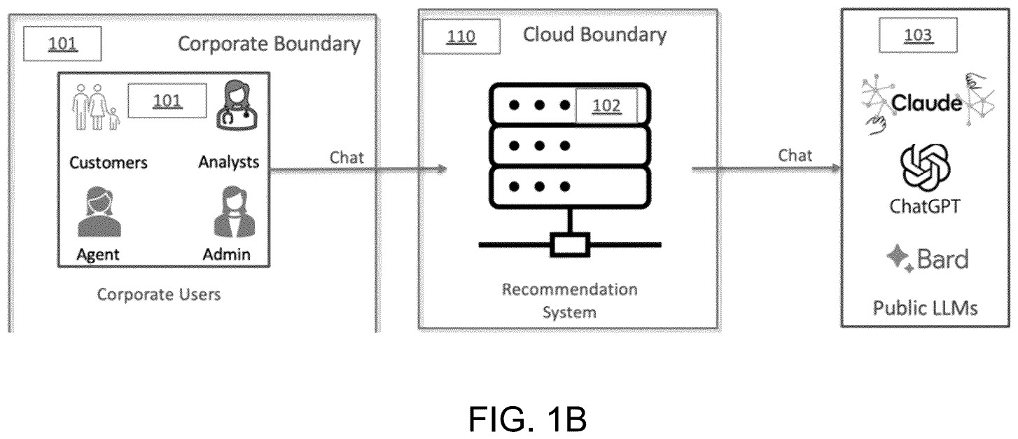

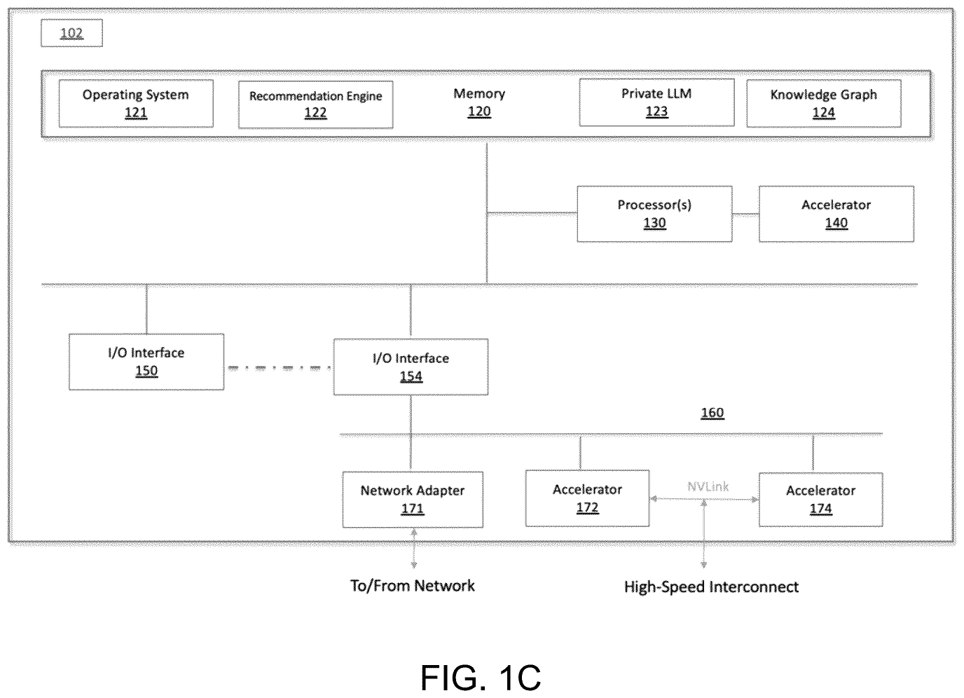

FIG. 1A is a block diagram that shows a recommendation system 102 that is deployed within a corporation 100 and is leveraged for more guided contextual conversations, requests and responses from users or other systems to block 103. The target systems are built on machine learning technologies, such as Large Language Models (LLM) or Generative Pretrained Transformers (GPTs), examples of which are shown in block 103. It should be noted that the GPTs shown in 103 are examples and can be extended to any external similar systems or internally deployed LLMs and GPTs. Beyond LLMs and GPTs, the described embodiments may employ any Generative AI (GenAI) systems.

FIG. 1B is a block diagram of the example recommendation system 102 deployed in the cloud 110 outside the corporate boundary or datacenter 100. Corporate users and systems 101 within the corporate boundary 100 are not permitted to interact with the LLMs and GPTs directly. All such conversation is directed to the recommendation system—in this case—deployed in the Cloud 110.

FIG. 1C is a high-level block diagram of console node 102. Node 102 is illustratively a computer system comprising a memory 120 coupled to one or more processors 130 which is coupled via multiple input/output (I/O) buses controlled via I/O interfaces 150 to 154. 154 is one such I/O interface that controls access via the I/O bus 160 to devices 170, 171 to 174. An example of a computer system that maybe used to implement the described embodiments is from Lambda Inc, 2510 Zanker Road, San Jose, California 95131.

Processor 130 is an illustrative conventional processor such as Intel Xeon 6448Y or AMD EPYC 9124 that can execute instructions and manipulate data contained in memory 120. 171 to 174 is an illustration of multiple Graphical Processing Units (GPUs) such as NVIDIA RTX A6000 or NVIDIA A-100 inter-connected, for example, using Nvidia's NVLink and via PCIe I/O bus 160. NVIDIA's NVLink enables GPUs to communicate with external accelerators (GPUs) over a high-speed network such as Infiniband. This enables a variety of scalable clustered configurations to meet performance needs. A more integrated accelerator 140 configuration ties with memory 120 and processor 130, called an Accelerated Processor Unit (APU), for example the Ryzen 3 3200G APU from AMD, provides an additional configuration for higher efficiency for the guidance system 102.

Memory 120 may be implemented using, e.g., dynamic RAM (DRAM) devices. Memory 120 comprises an operating system 121, recommendation engine 122, one or more private Large Language Models (LLMs) or GPTs 123, and Knowledge Graphs (KG) 124.

The operating system 121 is a conventional operating system that contains Software that enables Software, such recommendation engine 122, the LLMs 123 and the Knowledge Graphs (KG) software, to, inter alia, be scheduled for execution and to access various devices on node 102, such as network interface 170. An operating system that may be used with the described embodiments is the Ubuntu 22.x, an open source operating system.

The recommendation engine 122, one or more private Large Language Models (LLMs) or GPTs 123, and Knowledge Graphs (KG) 124 comprise computer executable instructions configured to implement aspects of the techniques described herein utilizing the example resources illustrated in FIG. 1C with special consideration given to the use of accelerators 140 used to make relevance or irrelevance decisions for conversations.

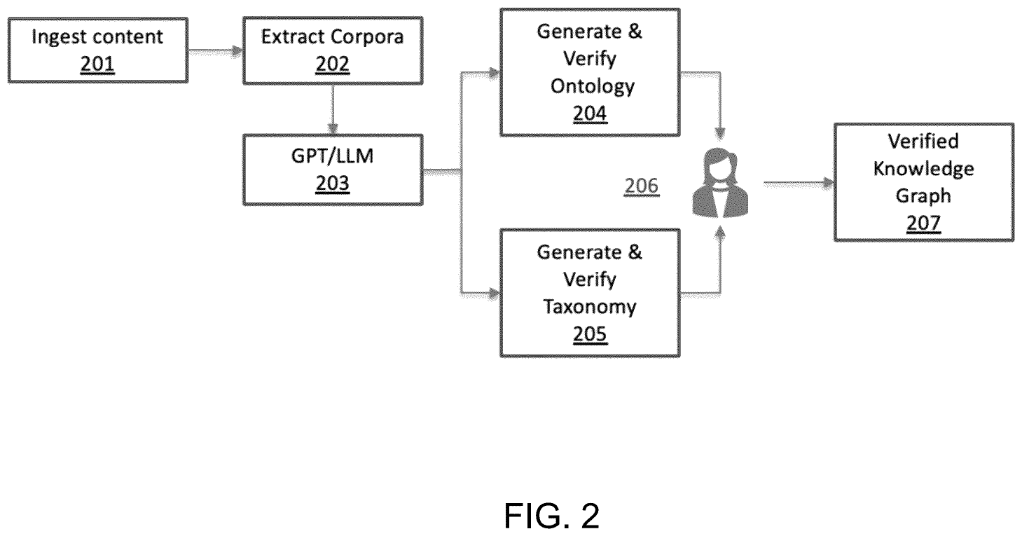

FIG. 2 is a flow chart of an example sequence of design time steps used to develop a verified knowledge graph 207 based on the on source content 201 ingested during design-time. Once the content is ingested, the associated corpora is extracted 202 through standard well known techniques such as parsing for structured content and OCR for unstructured content. with Human-in-the-Loop validation.

The extracted corpora may also be obfuscated with confidential and private information removed or replaced before sending it to an internal or external LLM or GPT 203. This obfuscation process is not shown here.

Based on the content, the LLM/GPT 203 generates an ontology 204 and a taxonomy 205 that are manually verified by a Human-In-The-Loop (HITL) 206. The verified ontology and taxonomy are then used to generate a verified knowledge graph 207 via HITL 206. The ontologies 204, taxonomies 205 and related knowledge graphs now serve as human verified “golden records.”

FIG. 3A is a block diagram that illustrates the Ontology definition at the atomic level. The purpose of the block diagram is to clarify some of the terminology used to define Ontology at the basic level. Some of the terms in the industry are used interchangeably to describe Ontology, and it causes confusion.

The first way to describe a basic Ontology is with 301, 302 and 303 where 301 and 303 are nodes and are linked by 302. Node 301's name is “Anxiety” and node 303's name is “Mental Health”. They are both bound by 302 referred to as a link which happens to be named “Type of.”

The second way to describe a basic Ontology is with 304, 305 and 306 where 304 and 305 are entities and are bound by 305. Entity 304's name is “Anxiety” and entity 306's name is “Mental Health”. They are both bound by 305 referred to as a relationship which happens to be named “Type of.”

The third way to describe a basic Ontology is with 307, 308 and 309 where 307 and 309 are subject and object and are bound by 308. Subject 307's name is “Anxiety” and object 309's name is “Mental Health.” They are both bound by 308 often referred to as a predicate which happens to be named “Type of.”

The point of FIG. 3A is to clarify the terminology where nodes, entities and subject/objects describe the same attributes in an Ontology, while link, relationship, and predicate mean the same thing when describing how the Ontology nodes, entities, subjects/objects are bound to each other. Throughout this disclosure FIG. 3A will be referenced to help clarify the terminology.

FIG. 3B is a block diagram that illustrates binding between ontologies, taxonomies and their relationships that are consumed at design time. In FIG. 3B, the taxonomy 300 is derived from source content such as a healthcare benefits document used as an illustrative example. The content can be generalized to any domain and is not restricted to healthcare.

Using the process and techniques described in FIG. 2, the ingested document results in a taxonomy 300 with 4 elements, Prosthetic Devices 301, Physical Assistance Devices 302, Durable Medical Equipment 304 and Prescription Drugs 303. The taxonomy is hierarchical and generally static since it builds a singular “subservice of” relationship between the elements listed. These elements are business objects and are grouped to meet business needs. The groupings are then subdivided for example Physical Assistance Devices 302 are subdivided into Prosthetic Devices 301 and Durable Medical Equipment 304 for illustrative purposes. The subdivision can continue till it captures the required elements presented in a set of ingested documents. A taxonomy 300 also serves the purpose of categorizing documents associated with elements in the taxonomy.

An ontology 310 related to healthcare benefits provides a more contextual representation of the source documents and has a wider array of relationships options between the elements. Ontologies allow us to organize the jargon of a subject area—healthcare benefits in this case—into a controlled vocabulary so as to retain the context and understanding of the document. A Healthcare Plan Modification Document 311 “has prior coverage” of Prosthetic Devices 312 and Mental Health Services 313. Along with the “has prior coverage” property, the “modified coverage” property for Prosthetic Devices 314 and Mental Health Services 315 provides the necessary understanding about the intent and understanding of the document 311.

With the taxonomy 300 and the ontology 310 in place, using techniques described in FIG. 2, a knowledge graph is then constructed to bind the ontology and taxonomy as depicted in FIG. 3B through the “has coverage of” property.

This provides a unique capability for recommending new services based on the elements once the relationship is established between an entity in the ontology, or guiding the conversation to topics that are still relevant to the conversation, however, may not be directly related to the sources document 311. For example, Prosthetic Devices 312 in the ontology and Prosthetic Devices 301 in the taxonomy are related with the property “has coverage of” capturing the intent.

Since Prosthetic Devices 301 is a sub service of Physical Assistance Devices 302 that in turn has Durable Medical Equipment 304 as a subservice, the recommendation system 102 can continue to intelligently consider these entities to be relevant conversation topics and not stop the user of system to communicate with a public or private LLM/GPT 103. One of the significant aspects of FIG. 2 is to build and generalize the relationship between the taxonomy and the ontology as a knowledge graph with properties such as “has coverage of” shown in dashed lines in FIG. 3B.

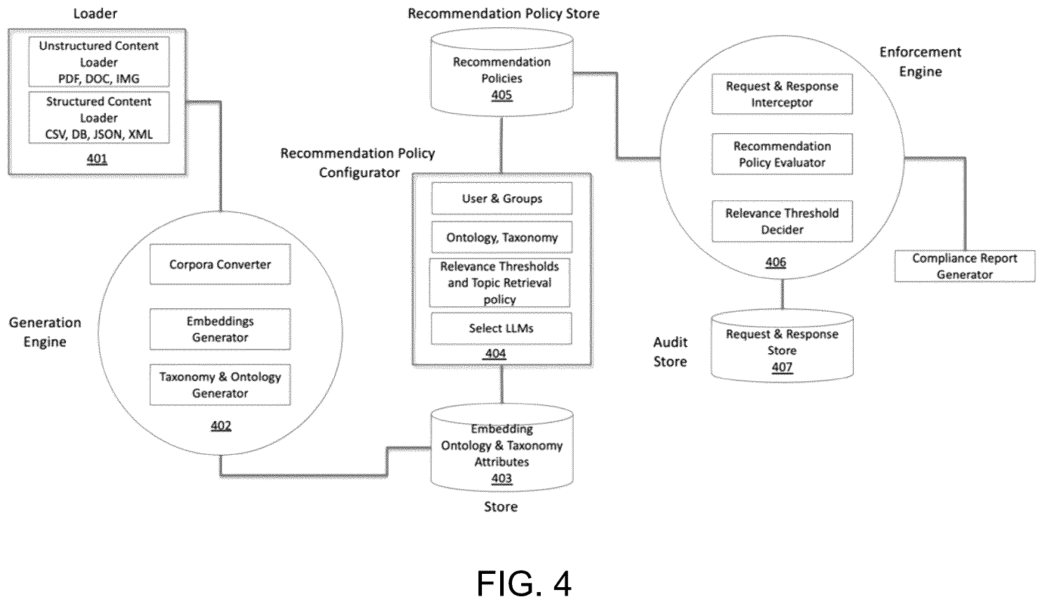

FIG. 4 is a block diagram of internal components of an example recommendation system that may employ the techniques. The Loader 401 is responsible for loading structured and unstructured content including PDF, DOC and IMG types. Structured content can be loaded as CSV files, direct Database calls or API invocation that return JSON/XML structures in real time or through batch. The loader can integrate with existing corporate systems to retrieve and load the data as necessary.

Once the content is loaded, the Generation Engine 402 is responsible for converting the content into a corpus through the Corpora Converter. Unstructured content such as images, faxes, and scanned documents go through a standard Optical Character Recognition (OCR) for conversion. Once the corpora is generated, the Embedding Generator builds an Embedding vector. Word embeddings fundamentally revolve around the idea that each word in a language can be denoted by a unique set of real-number values, essentially a vector. These vectors serve as learned representations, positioning words within an n-dimensional space. In this space, words sharing similar meanings exhibit closely situated vector representations, resulting in their proximity. The vectors are not just restricted to words and can be extended to sentences, phrases, paragraphs or entire documents. The primary objective when creating a word embedding space is to encapsulate specific associations within that space, whether they pertain to meaning, structure, context, or some other form of relationship. Word2Vec, GloVe, FastText, ELMo, BERT, USE (Universal Sentence Encoder), Transformer-based models (e.g., GPT-2, GPT-3, T5), Doc2Vec, Roberta, XLNet, DistilBERT, ALBERT, Sentence-BERT, OpenAI are a few examples of embedding engines that generate vectors with dimensions ranging from 50 to over 12,228.

Within the Generation Engine 402, the Taxonomy and Ontology generator is used to take the content corpora, send it to an external or internal LLM/GPT to have it generate the preliminary taxonomies and ontologies in a designated format such as JSONL. This component then utilizes the HITL process described in FIG. 2 and its automation verifies the taxonomies, ontologies and their related knowledge graphs and then utilizes neural networks to automate this process. The generated ontologies, taxonomies, knowledge graphs along with the embeddings and original corpora and content are all stored in a database 403. This database can be a single database or a combination of databases. For example, a vector database such as Pinecone, Weaviate, Chroma or Milvus can be used along with databases designed especially for knowledge graphs such as Neo4J, Amazon Neptune or GraphDB. A single database such as PostgreSQL may also be used as a store.

The Recommendation Policy Configurator 404 is a design-time component. It serves as the heart of the knowledge-driven conversation recommendation system in the development of conversation policies based on the insights derived from the extracted knowledge graph and the constructed taxonomy and ontologies. These policies are sets of rules, guidelines, or recommendations that steer the direction of conversations based on collection of relevant documents that align with a user query. They ensure that the interactions remain contextually relevant, accurate, and aligned with the available knowledge.

The Recommendation Policy Configurator 404 ties user groups with the ontologies, taxonomies and knowledge graphs in a way that guides the users to a relevant set of documents or topics that enhances their conversation experience. For a group of users, the Relevance Thresholds subcomponent of 404 employs NLP techniques to map mentioned entities to nodes in the knowledge graph. In addition, the Topic Retrieval subcomponent of 404 employs search techniques such as 2-hop, 3-hop or 4-hop to navigate through the taxonomy for additional recommendations.

The Recommendation Policy Configurator 404 also enables the administrator to select public and private LLMs/GPT for a user group. The selection of the LLMs ensures that the users are only interacting with approved external or internal LLMs. For the recommendation decision making process, the recommendation system is designed to leverage a custom knowledge graph that does not leave the corporate control and is built on proprietary corporate data. The recommendation system therefore guides the conversation with external and internal LLMs/GPTs based on the knowledge inherent to the corporate information and boundaries. The policies configured in 404 are subsequently stored in the Recommendation Policy Store 405.

The Enforcement Engine 406 loads policies from the Recommendation Policy Store 405 for policy enforcement. Its request and response interceptor subcomponent intercept the conversation between the user or system making a request to LLMs/GPTs 103. The request is then sent to the Recommendation Policy Evaluator subcomponent with the following purpose:
To retrieve documents that are closely aligned with the request. Based on the prescribed relevance thresholds, the system navigates through the predefined categories of the taxonomy and ontology inside the knowledge graph to accomplish the alignment task.
To recommend additional topics, phrases and documents that are related to the user request. Based on the prescribed relevance thresholds, and topic retrieval policies, the system navigates through the predefined categories of the taxonomy and ontology inside the knowledge graph to accomplish the recommendation task.

The LLM response is sent to the Recommendation Policy Evaluator subcomponent with the following purpose:
To recommend additional topics, phrases and documents that are related to the LLM response. Based on the prescribed relevance thresholds, and topic retrieval policies, the system navigates through the predefined categories of the taxonomy and ontology inside the knowledge graph to accomplish the recommendation task.

The continuous feedback loop of updated topics, documents and phrases during a conversation (requests, responses) doesn't stop as long as the request and response meet the prescribed relevance thresholds, as determined by the Relevance Threshold Decider. If the prescribed thresholds are not met, then the conversation would continue but without any feedback.

All requests and responses along with any transformed states such as obfuscated requests and responses are stored in the Audit Store 407. Compliance and security teams may then use the compliance report generator to audit reports to ensure compliance to corporate policies around privacy and ethics. The reports can also be used to further adjust the guidance engine policies.

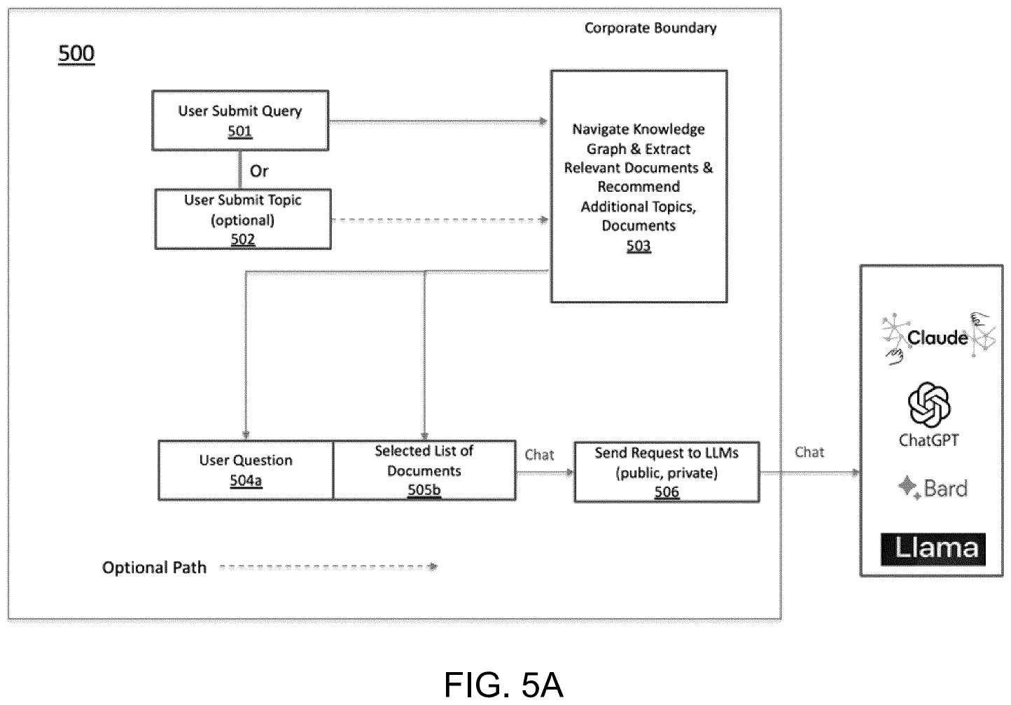

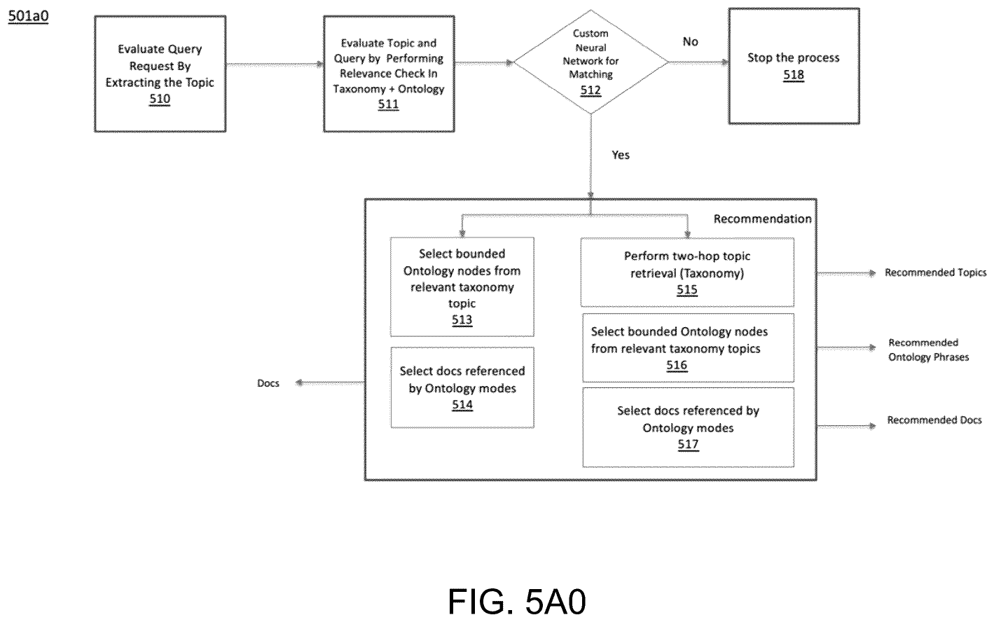

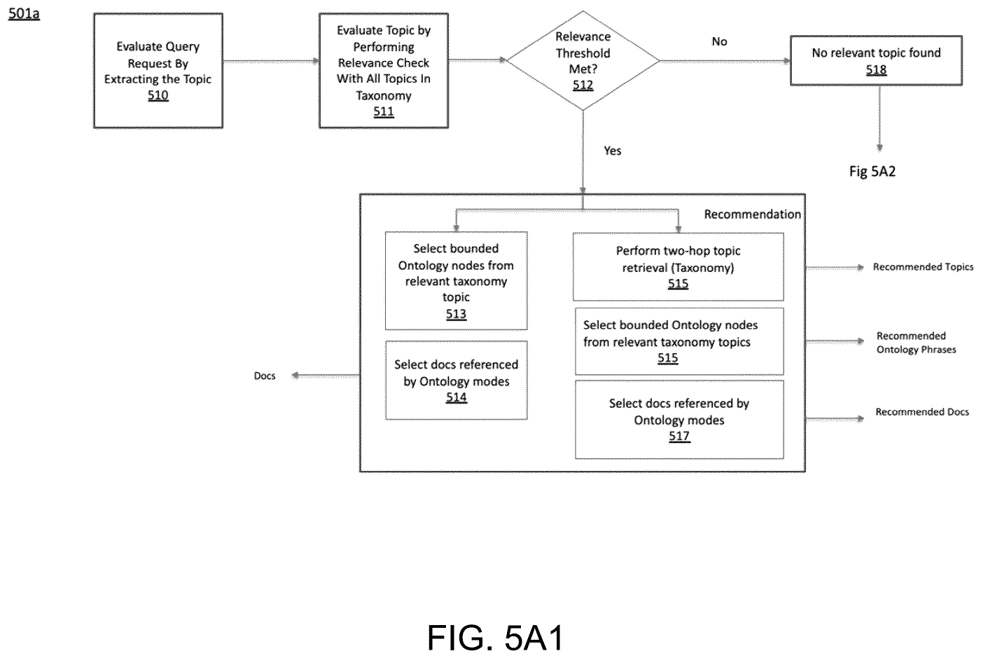

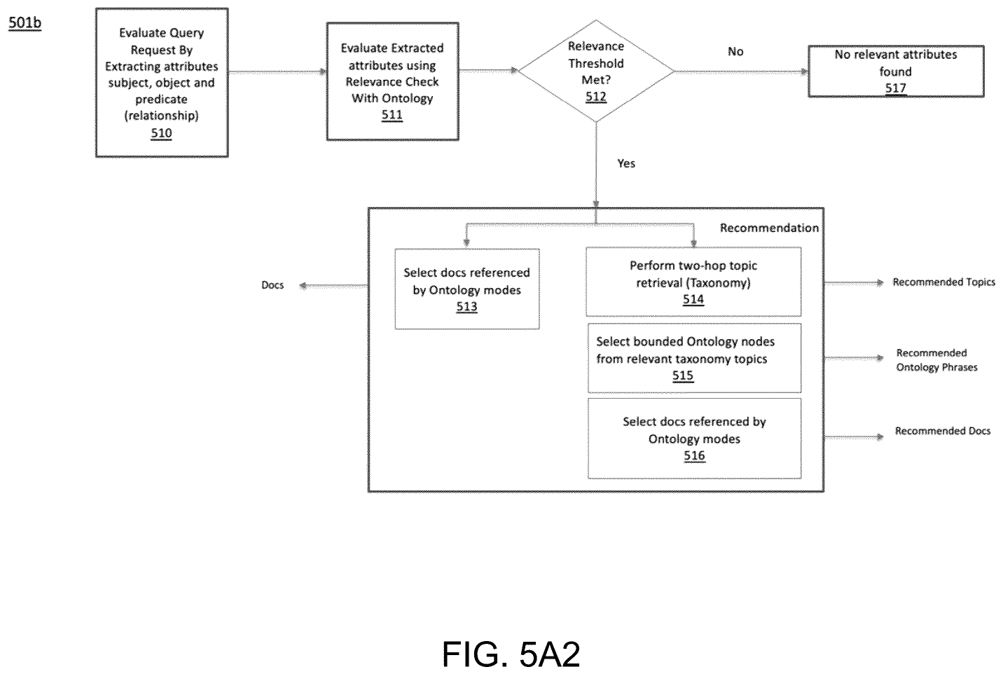

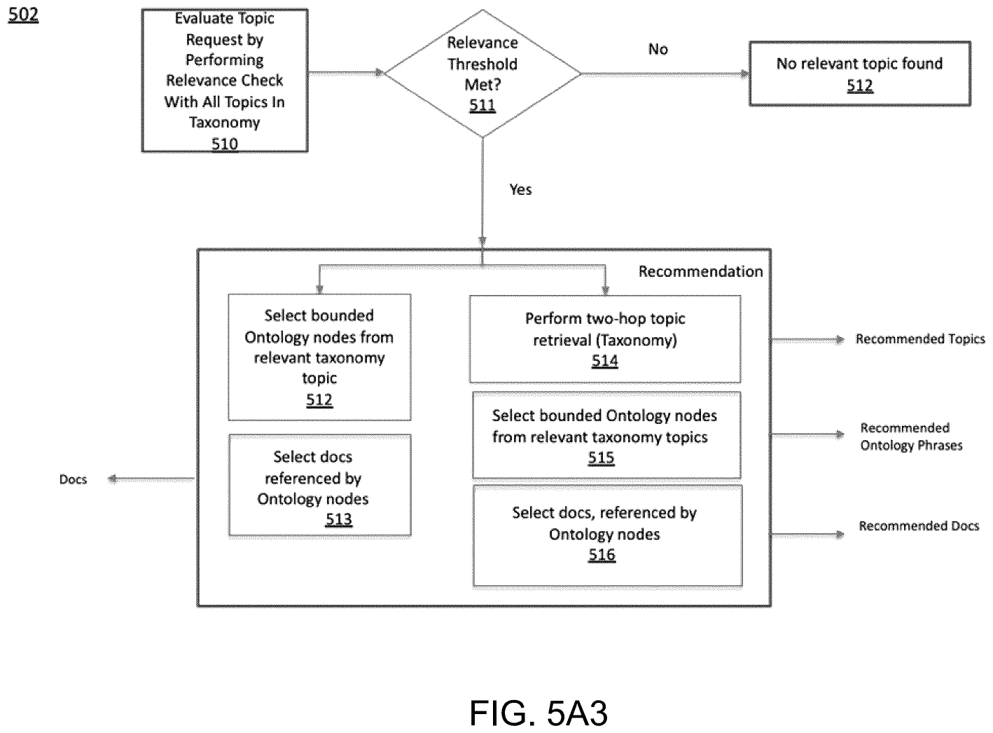

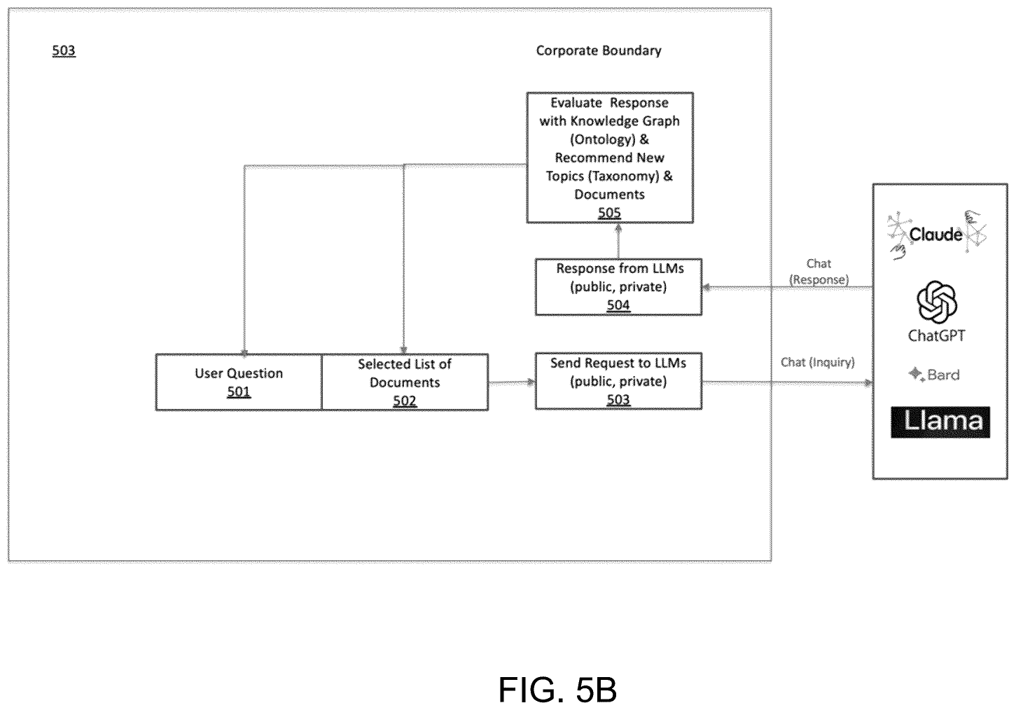

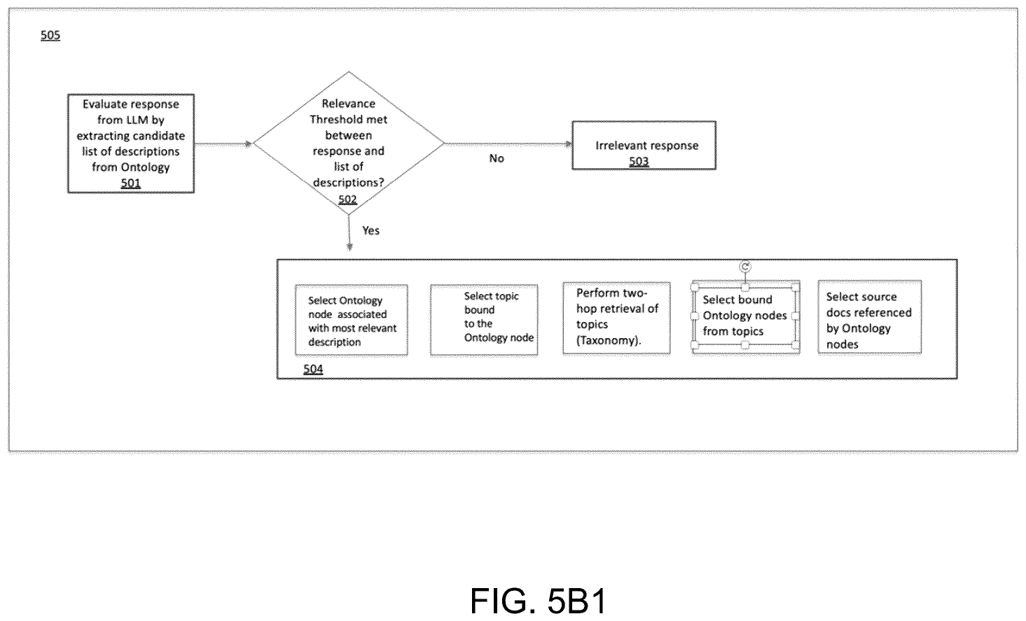

FIG. 5A is a high-level flowchart of the initial sequence of steps at 500 of a contextual conversational dialogue taking for example within a corporate boundary. The flowchart starts with two options, 501 or 502, initiated by a system application or user. A query (e.g., question) 501 is submitted to the recommendation system 503. Or topic of interest may be submitted by user or a system at 502 to the recommendation system 503.

Within 503, the recommendation system can take several different navigation paths where it can return documents relevant to the topic or query, and in addition recommend new topics and their relevant phrases and documents. All the multiple steps are detailed in FIG. 5A1, FIG. 5A2 and FIG. 5A3.

The relevant new taxonomy topic(s) of interest become the recommended topics or phrases that help guide a user or a system to generate a new question or a set of questions at 503a, in conjunction with a contextual reference to a collection of documents associated with those set of recommended topics at 503b.

Before techniques in 500 were introduced, a user or a system would initiate a contextual conversational dialogue with a question and often select documents using basic filters like title creation date or number of pages. However, these simple methods don't capture the nuanced relevance of a document's actual content. Fine-grained filters that involve semantic search though more sophisticated than basic filters still fall short of providing relevant documents of interest compared to a taxonomy organized topic. The taxonomy organized topics several advantages:
Structured Organization: Hierarchical relationships provide improved contextual understanding. Knowing how a topic fits within broader and narrower categories can provide insights into its significance and relevance. For example, a user performing a semantic search for topic “psychotherapy” may get “mental health” as a related topic. However, the semantic search doesn't reveal if a “psychotherapy” is a sub-topic of “mental health” or a “mental health” is a super-topic of “psychotherapy” and or is “mental health” a sibling of “psychotherapy”. When a taxonomy is available, a user can make better informed decisions of exploring related topics based on where other topics fit into the hierarchy and retrieve relevant source content (documents) associated with those topics.
Reduced Ambiguity: In a semantic search, the same term might refer to different concepts depending on the context. With a taxonomy, the hierarchical structure can clarify such ambiguities by showing where a term fits within the larger scheme.
Efficiency: When a taxonomy is well-structured, users can navigate to the information they need more quickly, without having to sift through potentially hundreds or thousands of semantic results.

Taxonomy based filters, which focus on content-derived topics, offer a more precise and effective way to identify relevant documents for a contextual conversational dialogue.

FIG. 5A0 is a flow chart of an overall sequence of steps based on an input of “topic” and a “query” that may be contextually searched using a custom trained neural network in 512. This custom neural network is a model that has been trained for a semantic search task (similarity learning) based on data from a taxonomy and an ontology.

A user or a system submits a query. A query is synonymous with a question. In 511, the system extracts a topic from the query. The taxonomy topic is extracted in 511 by sending the query to an external LLM and asking for a topic to be retrieved based on the query. Or in 511, a taxonomy topic can also be extracted by using a public knowledge graph such as wikidata where nouns are extracted from the query and using wikidata query API to find the common parent which can be identified as a topic for the nouns.

The main concept of 512 is to input both the taxonomy topic and the original query into a custom neural network. This may return a collection of the best-matched taxonomy and ontology pairs, which are interconnected or bounded together. The best-matched taxonomy topic and ontology pairs are then used to further present the user with additional documents, phrases and topics that are described in steps 513, 514, 515, 516, 517.

As an example of what the system is trying to accomplish, a user may ask the following: “Provide detailed information on my prior coverage for prosthetic equipment.” The system extracts two language constructs from the above user query:
A Taxonomy Topic that represents an overall theme of the subject matter in the query. “Prosthetic Devices” is an example of a topic that is identified from this user query.
Ontology is derived by extracting identifying key entities and relationships from the original query. An LLM could be leveraged to perform the extraction. FIG. 3A further provides examples of these.
   Subject: Prosthetic Equipment
   Relationship: Prior Coverage
   Object: Information

The taxonomy topic plus the ontology (entities and links) are fed into the system which happens to be the custom trained neural network. The neural network has been trained on high quality data using a well-designed loss function, where the high quality data has been curated by a human. The trained neural network then aids in retrieving the closest matched Taxonomy+Ontology in the Knowledge Graph.

The criteria for the neural network to retrieve the top matched Taxonomy+Ontology is based on the following three conditions:
1. Input Taxonomy topic semantically matches closest to the taxonomy topic from the trained neural network
AND
2. Input Ontology semantically matches closest to the Ontology from the trained neural network
AND
3. Taxonomy Topic from the Neural Network matches closest to one of the entities in the Ontology of the trained neural network. This satisfies the binding criteria. The last condition is key to having a highly accurate match.

The following description provides a brief background on the building blocks of the loss function. The custom neural network accuracy in searching the combined two inputs (Taxonomy+Ontology) is based on the robustness of the loss function and the architecture of the neural network. It is the design of the loss function that will determine how well the trained neural network model performs.

A brief description helps build the intuition about the pivotal role played by loss function in a neural network. The design of the loss function is crucial in the training of data in a neural network because it is responsible for measuring the difference between the predicted output and the actual output of the model. The loss function is used to optimize the model by minimizing the loss, which means that the model makes fewer mistakes on the training data.

Different types of loss functions are used for different types of problems. For example, mean squared error (MSE) is commonly used for regression problems, while cross-entropy loss is used for classification problems. Choosing the right loss function is important because it affects the model's ability to learn and generalize to new data. A poorly chosen loss function can lead to overfitting or underfitting of the model.

Loss functions also provide more than just a static representation of how the model is performing. They are how the algorithms fit data in the first place. If the predictions are off, the loss function will output a higher number. If they are good, it will produce a lower number. As the algorithm is experimented with to try and improve the model, the loss function will tell if it is getting anywhere.

In summary, the loss function is a critical component of neural network training, and choosing the right loss function is important for the model's ability to learn and generalize to new data. When it comes to similarity learning of sentences, phrases, or for text data, the current state-of-the-art model is a Siamese Network. This network structure involves two identical subnetworks that accept individual inputs, sharing the same parameters and weights. The outputs from these subnetworks are interconnected, making it possible to optimize the loss function effectively and enhance the model's ability to understand and capture complex relationships within the data.

The architecture of a neural network dictates how it processes input data, the nature of functions it can approximate, how well it can generalize, and many other pivotal aspects of its performance.

### How It Works

Twin Networks: The two identical subnetworks process two different input vectors. Even though they are ‘twin’ networks, the input they take can be different.

Distance Metric: After processing the inputs, the network's output feature vectors for each input. A distance metric (e.g., Euclidean distance, Manhattan distance, or others) is then used on these feature vectors to determine how similar (or different) the two inputs are.

Loss Function: For training, Siamese Networks commonly use a “contrastive loss” or “triplet margin loss.” The basic idea is to minimize the distance between similar pairs and maximize the distance between dissimilar pairs.

Contrastive Loss: Given a pair of inputs and a label indicating if the pair is similar or not, the loss function tries to minimize the distance between similar items and ensure that the distance between dissimilar items is greater than a certain margin.

Triplet Margin Loss: This involves three inputs: an anchor, a positive sample (similar to the anchor), and a negative sample (dissimilar to the anchor). The aim is to ensure that the anchor is closer to the positive sample than it is to the negative sample by at least a margin.

Consider the following sentence pairs, with a label indicating if they're semantically similar (1) or not (0):
Sentence A1: “Prosthetic equipment.” Sentence B1: “Prosthetic devices.” Label: 1 (similar)
Sentence A2: “Toothbrush.” Sentence B2: “Razor.” Label: 0 (not similar)

Sentences (A1, B1) are a pair of similar sentences that are fed into the siamese network for training while Sentences (A2, B2) are dissimilar sentences that are also fed into the siamese network.

Triplet Margin Loss is one of the most popular loss functions used for similarity learning. The formula for the Triplet Margin Loss and the description is provided below:
The basic idea behind the triplet loss is that you have three data points: an anchor, a positive, and a negative sample. The objective is to ensure that the anchor is closer to the positive sample than it is to the negative sample by at least a margin.

### Formula

Given:
A: Embedding for the anchor sample.
P: Embedding for the positive sample (similar to anchor).
N: Embedding for the negative sample (dissimilar to anchor).
α: Margin, a hyperparameter to ensure that positive and negative pairs are separated by at least this distance.
The Triplet loss L is defined as:

$$L = max ( 0 , {‖ A - P ‖}^{2} - {‖ A - N ‖}^{2} + α )$$

Where:
   ||.||² denotes the squared L2 norm (Euclidean distance).

### Description

   ||A−P||² is the squared distance between the anchor and the positive sample. You want this to be small since A and P are similar.
   ||A−N||² is the squared distance between the anchor and the negative sample. You want this to be large, or at least larger than the distance to the positive by a margin of α.
The max function ensures that if the distance between A and P is more than the distance between A and N minus the margin, the loss will be zero. Otherwise, the network gets penalized.
The margin α is crucial. If A is already closer to P than N by at least α, the loss is zero. Otherwise, the loss encourages the network to adjust the embeddings such that this condition is met.
In essence, the triplet loss ensures that the positive sample remains closer to the anchor than the negative sample by a specific margin. If this condition isn't satisfied, the network is penalized and the embeddings are adjusted during training.

The technique introduced here is to extend the Triplet Loss Function to accommodate the architecture of the Knowledge Graph that is composed of three components:
Taxonomy
Ontology
Binding of Taxonomy to Ontology

With the above in mind, the technique extends the Triplet Margin Loss Function to a KG Margin Loss Function.

Definitions:
T=Taxonomy
O=Ontology
A=Anchor
P=Positive
N=Negative
d=distance

i) Defining Taxonomy Loss:
T(A)=Embedding for the taxonomy topic anchor example
T(P)=Embedding for the taxonomy topic positive example
T(N)=Embedding for the negative taxonomy sample (dissimilar to anchor)
T(Ω)=Margin, a hyperparameter to ensure that positive and negative pairs are separated at this distance.

$$L ( T ) = max ( 0 , d ( T ( A ) , T ( P ) ) - d ( T ( A ) , T ( N ) ) + T ( Ω ) )$$

ii) Defining Ontology Loss:
O(A)=Embedding for the ontology entities anchor example
O(P)=Embedding for the ontology entities positive example
O(N)=Embedding for the negative ontology sample (dissimilar to anchor)
O(Ω)=Margin, a hyperparameter to ensure that positive and negative pairs are separated at this distance.

$$L ( O ) = max ( 0 , d ( O ( A ) , O ( P ) ) - d ( O ( A ) , O ( N ) ) + O ( Ω ) )$$

Defining Binding Loss:
O(Pi)=Embedding of only one ontology entity (node) as an anchor example
O(Ni)=Embedding of only one ontology entity (node) as an negative example
B(Ω)=Margin, a hyperparameter to ensure that positive and negative pairs are separated at this distance.

$$L ( B ) = max ( 0 , d ( T ( A ) , O ( P i ) - d ( T ( A ) , O ( Ni ) ) + B ( Ω ) )$$

The resulting KG Triplet Loss results in the mean of the L(T), L(O), L(B):

$$L ( T , O , B ) = mean ( max ( 0 , d ( T ( A ) , T ( P ) ) - d ( T ( A ) , T ( N ) ) + T ( Ω ) ) + max ( 0 , d ( O ( A ) , O ( P ) ) - d ( O ( A ) , O ( N ) ) + O ( Ω ) ) + max ( 0 , d ( T ( A ) , O ( Pi ) - d ( T ( A ) , O ( Ni ) ) + B ( Ω ) ) ) ,$$

which results in the following:

$$L ( T , O , B ) = mean ( L ( T ) + L ( O ) + L ( B ) )$$

In some embodiments, the L(T, O, B) may be a mean as shown; in other embodiments, it may be a weighted average where more weight could be given to either one of the individual Loss Functions while the remaining loss functions could receive less weightage.

FIG. 5A1 is a flowchart of a more detailed sequence of steps that may be used during an initial contextual conversational dialogue. This sequence of steps described in 501a is a detailed breakdown of steps of sub-component 503, Recommendation System, in FIG. 5A.

A user or a system submits a query. A query is synonymous with a question. In 510, the system extracts a topic from the query. The topic is extracted in 510 by sending the query to an external LLM and asking for a topic to be retrieved based on the query. Or in 510, a topic can also be extracted by using a public knowledge graph such as wikidata where nouns are extracted from the query and using wikidata query API to find the common parent which can be identified as a topic for the nouns.

Once the topic is retrieved then a relevance check is performed against the taxonomy topics in 511. If the given topic does not match the predefined relevance threshold metric, the system moves to 518 and initiates a new execution path defined in FIG. 5A2.

If the threshold metric is met in 511, the most relevant topic in the taxonomy is selected. The Ontology bound to the most relevant topic is selected in 512. Once the Ontology is selected, it leads to 513 where the documents tied to Ontology are retrieved.

While 512 and 513 steps are taken, the system may also perform a two-hop retrieval of taxonomy topics in 514. The two-hop retrieval entails taking the most relevant topic in 511 and retrieving the parent and grandparent taxonomy topics in 514. The topics become the recommended topics. The recommended topics are bound to an Ontology in 515. The bounded Ontology are tied to phrases (descriptions) that become the recommended phrases. Then in 516 the documents tied to Ontology are retrieved and presented as recommended documents.

To summarize, documents tied to the original request in 510 are retrieved and presented by the system for conversational dialogue. Additionally, recommended topics, phrases and documents are also presented by the system for the user to use as part of the conversational dialogue.

FIG. 5A2 is a continuation of a sequence of steps that are invoked if the system reaches 518 in FIG. 5A1. The system reaches 501b in FIG. 5A2. In 510, the system tokenizes and converts the original user query using NLP techniques based on syntactic rules to generate Ontology triplets that look similar to examples of FIG. 3A. These generated Ontology triplets are semantically matched, in 511, with the most relevant Ontology entities (nodes) and relationships (links) of the knowledge graph.

### Part 1: Syntactic Generation Rules to Tokenize Query for Ontology Search in 510

In 510, the rules to generate Ontology triplets are based on two syntactic structure techniques in the field of computational linguistics:

Part-of-Speech (POS) Tagging: It is the process of assigning a specific tag to each word in a sentence based on its grammatical role and content. These tags represent the part of speech of each word, such as noun, verb, adjective, pronoun, conjunction and so on. POS tagging is an essential task in NLP, as it helps in understanding the meaning of a sentence and identifying the relationships between words.

### Example POS:

```
Query: “Can I use acupuncture for anxiety relief”
Extracted POS Tags represented in JSON format:
{“Can”: “Auxiliary”,
  “I”, “Pronoun”,
  “use”: “Verb”,
  “acupuncture”, “Noun”,
  “for”: “Preposition”,
  “anxiety”, “Noun”,
  “relief”', “Noun”
}
```

Dependency Parsing (DP): The purpose of Dependency Parsing in NLP is to analyze the grammatical structure of a sentence and identify the relationship between words. It helps in understanding the meaning of a sentence by identifying the subject, object, predicate and other parts of speech. Dependency Parsing is used in various NLP applications such as text classification, sentiment analysis, and machine translation. It is also used in question answering systems, chatbots and information retrieval systems.

### Example DP:

Query: “Can I use acupuncture for anxiety relief”

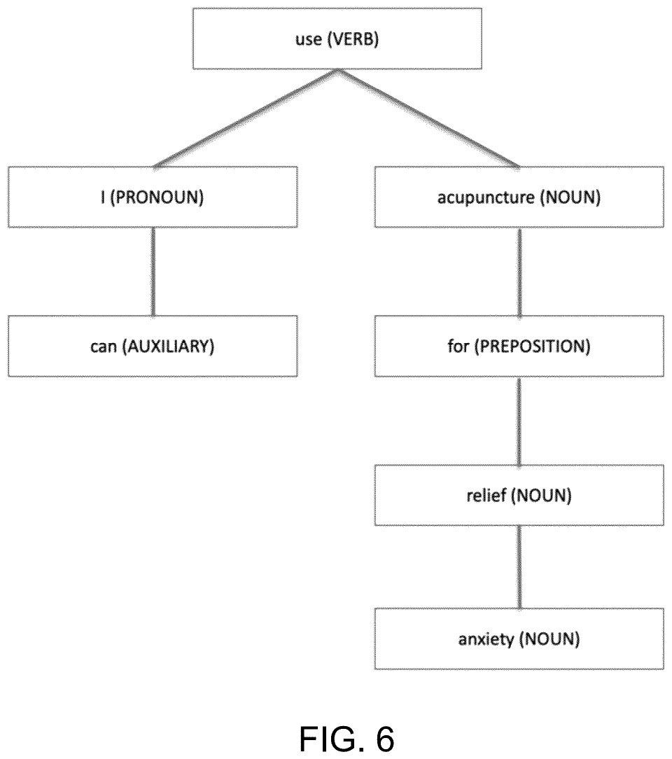

Refer to FIG. 6 for a flow diagram associated with this example. In this query, the verb is “use” that defines the relationship or link between entities. Verb is always the root node in a dependency tree and it defines the relationship between various entities. The other entities of interest besides the verb are the nouns that define the nodes. Other classes of words besides verbs and nouns are ignored when a triplet Ontology is generated based on the input query.

What follows is a step-by-step approach to accomplish tasks of 510 using POS and DP:
1. Perform dependency parsing on the query input using a suitable NLP open source library. This will generate a dependency parse tree for the input query
2. Extract the necessary tokens by walking the nodes of the dependency parse tree, and build the Ontology triplets. This can be done by identifying the subject, object, and predicate sets of the sentence from the DP tree and filtering out unnecessary query tokens such as prepositions, determiners, and pronouns using POS.

Below is sample Python code to extract the Ontology triplet for input query: “Can I use acupuncture for anxiety relief.”

| | |
|---|---|
| 1. | import spacy |

2.

| | |
|---|---|
| 3. | # Load the English language model |
| 4. | nlp = spacy.load(‘en_core_web_sm’) |

5.

| | |
|---|---|
| 6. | # Define a sample sentence |
| 7. | sentence = “Can I use acupuncture for anxiety relief?” |

8.

| | |
|---|---|
| 9. | # Parse the sentence using spaCy |
| 10. | doc = nlp(sentence) |

11.

| | |
|---|---|
| 12. | # Print the dependency tree for the sentence |
| 13. | for token in doc: |
| 14. | print(token.text, token.dep_, token.head.text, token.head.pos_, |
| 15. | [child for child in token.children]) |

16.

| | |
|---|---|
| 17. | # Function to assemble compound nouns |
| 18. | def get_compound_phrase(token): |
| 19. | return ‘ ’.join([child.text for child in token.children if |

child.dep_ == ‘compound’] + [token.text])
20.

| | |
|---|---|
| 21. | # Recursive function to traverse the tree |
| 22. | def traverse_tree(node): |
| 23. | extracted_info = [ ] |

24.

| | |
|---|---|
| 25. | if node.pos_ in [‘VERB’, ‘NOUN’]: |
| 26. | if node.dep_ == ‘compound’: |
| 27. | return [ ] |
| 28. | elif node.pos_ == ‘NOUN’ and any(child.dep_ == ‘compound’ |

for child in node.children):

| | |
|---|---|
| 29. | extracted_info.append(get_compound_phrase(node)) |
| 30. | else: |
| 31. | extracted_info.append(node.text) |

32.

| | |
|---|---|
| 33. | for child in node.children: |
| 34. | extracted_info.extend(traverse_tree(child)) |

35.

| | |
|---|---|
| 36. | return extracted_info |

37.

| | |
|---|---|
| 38. | # Finding the root token and starting the tree traversal |
| 39 | root_token = [token for token in doc if token.dep_ == ‘ROOT’][0] |
| 40. | result = traverse_tree(root_token) |
| 41. | print(“\nExtracted Nouns, Verbs, and Compound Noun Phrases:”) |
| 42. | print(result) |

When the sample python code is executed then the final output is as follows:
[‘acupuncture’, ‘use’, ‘anxiety relief’]

[‘acupuncture’, ‘use’, ‘anxiety relief’] becomes the final input to 511 as the primary key to search Ontology in the Knowledge Graph.

### Part 2: Semantic Matching Rules to Extract the Most Relevant Ontology Node(s) in 511 and 512

Given the tokenized triplets of verbs (relationships) and nouns (entities), the search for the Ontology nodes and links within the Knowledge Graph is activated. The search is not a brute force search but an NLP based semantic search.

Approach for Matching Triplets Using Divide and Conquer in 511 and 512:
1. Vectorization of Input Query Triplets:
   Convert each element of the triplet (subject, predicate, object) into vector representations using embeddings.
2. Cosine Similarity Calculation:
   Compute the cosine similarity between the vectors of the input triplet and each triplet in the Knowledge Graph
   Filter and return the triplets that have a similarity score of 0.80 or higher. Similarity score of 0.80 is just an example, and it is a variable parameter that can be set by the user as part of the configuration policy.
3. Divide and Conquer Strategy:
   If no matches are found based on a given threshold for the full input triplet, start partitioning:
      a. Begin by splitting the input triplet into pairs, excluding the predicate when it's isolated. This results in combinations like (subject, predicate), (predicate, object), and (subject, object).
      b. Compute similarity for each of these pairs against the Knowledge Graph.
      c. If still no match is found, further partition into individual tokens but avoid considering the predicate on its own.
      d. A key technique is to use the technique of ‘Adaptive Thresholding’ where the original threshold value increases or becomes stricter in matching criteria as the number of tokens are removed. It is based on a nonlinear function as shown below:

$$x ( n ) = {x}_{max} - \frac{A}{1 + {e}^{k ( n - m )}}$$

### Where:

A is the range, A=xₘₐₓ−x_{base}.
m is the mid-point, which is where half the tokens are. So

$$m = \frac{{N}_{max}}{2} .$$

k determines the steepness of the curve. Larger values of k result in a steeper transition.

### Given:

x_{base}=0.90
xₘₐₓ=0.95
Nₘₐₓ=8 (for the example where we started with 8 tokens)

Consider a sentence as a team of players in a relay race. Each player, or token, contributes to the team's overall performance. In the context of semantic search, the team's performance is the ability of the sentence to match another sentence or a set of tokens (a collection of nodes and links) from the KG semantically.

Now, if we start removing players from our team, each remaining player needs to put in extra effort to maintain or improve the team's overall performance. Similarly, as we remove tokens from our sentence, the importance of each remaining token increases, making it more vital for the overall semantic intent of the sentence.

The dynamic thresholding approach of the described embodiments reflects this intuition. As more tokens are removed, we raise the bar or threshold for the remaining tokens.
Repeat the similarity calculation and filtering steps for each partition based on a new threshold value.
Return the Best Match:
Return the top matching triplet based on the highest similarity score found across all partitions.

The following is a sample Python code of 511 and 512 based on previous steps:

| | |
|---|---|
| 1. | import spacy |
| 2. | import jsonlines |
| 3. | import math |
| 4. | from sklearn.metrics.pairwise import cosine_similarity |
| 5. | from itertools import combinations |

6.

| | |
|---|---|
| 7. | # Load the spaCy model with word vectors |
| 8. | nlp = spacy.load(′en_core_web_lg′) |

9.

| | |
|---|---|
| 10. | def vectorize(text): |
| 11. | return nlp(text).vector |

12.

| | |
|---|---|
| 13. | def compute_similarity(triplet1, triplet2): |
| 14. | return sum(cosine_similarity([vectorize(triplet1[i])], [vectorize(triplet2[i])])[0][0] for |

i in range(min(len(triplet1), len(triplet2)))) / min(len(triplet1), len(triplet2))
15.

| | |
|---|---|
| 16. | def find_matching_triplets(input_triplet, knowledge_graph_file, threshold): |
| 17. | matched_triplets = [ ] |

18.

| | |
|---|---|
| 19. | with jsonlines.open(knowledge_graph_file) as reader: |
| 20. | for triplet in reader: |
| 21. | similarity = compute_similarity(input_triplet, triplet) |
| 22. | if similarity >= threshold: |
| 23. | matched_triplets.append((triplet, similarity)) |

24.

| | |
|---|---|
| 25. | # Sort based on similarity |
| 26. | matched_triplets.sort(key=lambda x: x[1], reverse=True) |
| 27. | return matched_triplets |

28.

| | |
|---|---|
| 29. | def adaptive_threshold_calculation(base_threshold, max_threshold, midpoint_m, |

n_tokens_removed,

| | |
|---|---|
| 30. | k_steep) |
| 31. | A = max_threshold − base_threshold |
| 32. | return (max_threshold − (A/(1 + math.exp(k_steep(n_tokens_removed − |

midpoint_m)))))
33.

| | |
|---|---|
| 34. | def divide_and_conquer(triplet, knowledge_graph_file, base_threshold, max_threshold, |

k_steep):
35.

| | |
|---|---|
| 36. | partitions = [triplet] |
| 37. | midpoint_m = len(triplet)/2 |
| 38. | threshold = base_threshold |
| 39. | original_token_len = len(triplet) |

40

| | |
|---|---|
| 41. | # Create combinations of 2 tokens |
| 42. | partitions.extend(combinations(triplet, 2)) |

43.

| | |
|---|---|
| 44. | # Create combinations of individual tokens and exclude the predicate (index 1) |
| 45. | single_token_partitions = [token for i, token in enumerate(triplet) if i != 1] |
| 46. | partitions.extend(single_token_partitions) |
| 47. | for partition in partitions: |
| 48. | matches = find_matching_triplets(partition, knowledge_graph_file, threshold) |
| 49. | if matches: |
| 50. | return matches [0] |
| 51. | # Calculate a new threshold metric since we will be removing the tokens |
| 52. | n_tokens_removed = original_token_len − len(partition) |

53

| | |
|---|---|
| 54. | if n_tokens_removed > 1: |
| 55 | threshold = adaptive_threshold_calculation(base_threshold, max_threshold, |

midpoint_m,

| | |
|---|---|
| 56. | n_tokens_removed, k_steep) |

57.

| | |
|---|---|
| 58. | return None |

59.

| | |
|---|---|
| 60. | # Sample Input |
| 61. | input_triplet = (″acupuncture″, “use”, ″anxiety relief″) |

62.

| | |
|---|---|
| 63. | # Load Knowledge Graph and find matches |
| 64. | knowledge_graph_file = ‘knowledge_graph.jsonl’ |
| 65. | base_threshold = 0.80 |
| 66. | max_threshold = 0.95 |
| 67. | k_steep = 0.5 |
| 68. | match = divide_and_conquer(input_triplet, knowledge_graph_file, base_threshold, |

max_threshold, k_steep)

| | |
|---|---|
| 69. | if match: |
| 70. | top_match, similarity = match |
| 71. | print(f″Top Matching Triplet: {top_match} with similarity: {similarity:.2f}″) |
| 72. | else: |
| 73. | print(″No matches found with the given threshold.″) |

By following these steps, the system can use dependency parsing on query input to build Ontology triplets, which can then be used to semantically search the Ontology component of the knowledge graph.

If no set of relevant Ontology nodes or a set of nodes with their respective links are found, then the system reaches 517.

If the threshold metric is met in 512, given the Ontology selected, it leads to 513 where the documents tied to Ontology are retrieved.

While 513 is executed, the system may also perform a two-hop retrieval of taxonomy topics in 514. The system can reach these taxonomy topics via the Ontology node that was selected as the most relevant match in 512. The Ontology node is always bound to a taxonomy node. The topics from two-hop retrieval become the recommended topics. The two-hop is just an example of a retrieval strategy. It could be an n-hop strategy where n>=1.

The recommended topics are bound to an Ontology in 515. The bounded Ontology are tied to phrases (descriptions) that become the recommended phrases.

Then in 516 the documents tied to an Ontology are retrieved and presented as recommended documents.

To summarize, documents tied to the original request in 510 are retrieved and presented by the system for conversational dialogue. Additionally, recommended topics, phrases and documents are also presented by the system for the user to use as part of the conversational dialogue.

FIG. A3 is a flowchart of a more detailed sequence of steps that may be used during an initial contextual conversational dialogue. This sequence of steps described in 502 of FIG. A3 is a detailed breakdown of steps of sub-components 502 and 503 of Recommendation System, in FIG. 5A.

A user or a system optionally can select a topic instead of a detailed query or question. Once the topic is retrieved then a relevance check is performed against the taxonomy topics in 511. If the given topic does not match the predefined relevance threshold metric, the system moves to 512 and ends the steps of retrieval.

If the threshold metric is met in 511, the most relevant topic in the taxonomy is selected. The Ontology bound to the most relevant topic is selected in 512. Once the Ontology is selected, it leads to 513 where the documents tied to Ontology are retrieved.

While 512 and 513 steps are taken, the system may also perform a two-hop retrieval of taxonomy topics in 514. The two-hop retrieval entails taking the most relevant topic in 511 and retrieving the parent and grandparent taxonomy topics in 514. The topics become the recommended topics. It should be noted that two-hop retrieval is an example strategy. The system can perform a n-hop retrieval strategy based on user policy configuration in FIG. 4.

The recommended topics are bound to an Ontology in 515. The bounded Ontology are tied to phrases (descriptions) that become the recommended phrases.

Then in 516 the documents tied to Ontology are retrieved and presented as recommended documents.

To summarize, documents tied to the original request in 510 are retrieved and presented by the system for conversational dialogue. Additionally, recommended topics, phrases and documents are also presented by the system for the user to use as part of the conversational dialogue.

FIG. 5B is a flowchart of a sequence of steps that may be used during the response phase 504 of a contextual conversational dialogue 503. Based on the response from the LLM in 504, the response may be submitted to recommendation system 505 that provides improved feedback to 501 with a new set of recommended topics and 502 with the associated source documents. The steps taken within 505 entail retrieving the Ontology closest to the response and then using two-hop retrieval technique to select new taxonomy topics with the associated set of documents. The topics selected are consumed by the user as a guide to ask more pertinent questions in conjunction with the related documents as contextual reference.

FIG. 5B1 is a flowchart of a more detailed sequence of steps that may be used during a response of a contextual conversational dialogue. This sequence of steps described in 505 is a detailed breakdown of steps of sub-component 505, Recommendation System, in FIG. 5B.

The first step of processing the response from an LLM in 501 is to generate a generic graph query, for example based on the Cypher standard.

The advantage of using a generic query is that (1) it's easily adaptable for other responses with slight changes, like adding an ID, and (2) it's more reliable than using an LLM, which might not always produce accurate graph queries due to its unpredictable nature.

An example query may be:
MATCH (n:PlanModification {cid:‘{var_cid}’})--(m) RETURN m.description

This graph query returns a list of descriptions that are tied to Ontology nodes associated with customer ID variable {var_cid}. In 501, a generic query expedites the extraction of Ontologies containing their respective descriptions. The system in 501, using Natural Language Processing (NLP) technique of semantic similarity, takes the response and matches it with the closest description.

The sample code to execute the above technique is show below:

| | |
|---|---|
| 129 | cyquery = “MATCH (n:PlanModification (cid: ‘1’))—(m) RETURN m.description, m.coverage” |
| 130 | |
| 131 | output_string = response |
| 132 | |
| 133 | [symbol] Connect to the database and execute the query |
| 134 | with GraphDatabase.driver(url) as driver: |
| 135 | with driver.session( ) as session: |
| 136 | result = session. [symbol] (cyquery) |
| 137 | |
| 138 | [symbol] Process the results, remove null values |
| 139 | nodes = [ ] |
| 140 | for record in result: |
| 141 | description = record [symbol] “m.description” [symbol] |
| 142 | coverage = record[“m.coverage”] |
| 143 | [symbol] description: |
| 144 | description_sentences = [ [symbol] .strip( ) for [symbol] in re.sp [symbol] ‘[.17]’, description) if s.strip( )] |
| 145 | node = (description_sentences. coverage) |
| 146 | nodes.append(node) |
| 147 | |
| 148 | descriptions = set(sentence for node in nodes for sentence in node[0]) |
| 149 | coverages = set(node[ [symbol] ] for node in nodes) |
| 150 | |
| 151 | [symbol] Computer embedding for the [symbol] output |
| 152 | embedding [symbol] = model. [symbol] (output_string, covert_to_ten [symbol] True) |
| 153 | |
| 154 | highest_similarity = [symbol] |
| 155 | [symbol] Compute cosine similarity between the [symbol] |
| 156 | most_similar_descriptions = ”” |
| 157 | for description in descriptions: |
| 158 | [symbol] ings2 = [symbol] (descriptions, convert_to_tens [symbol] True) |
| 159 | cosine_scores = util.pytorch_ [symbol] (embeddings1, embeddings2) |
| 160 | similarity = cosine_scores,item( ) |
| 161 | if similarity > highest_similarity: |
| 162 | highest_similarity = similarity |
| 163 | most_similar_description = decription |

[symbol]

indicates data missing or illegible when filed

In 502, the threshold check is performed. If the threshold parameter set for the match is met, then the system continues to 504 otherwise it stops on its tracks in 503 leading to no more recommendations.

In 504, further steps are performed by the system as follows:
Select Ontology node associated with most relevant description: The Ontology node is selected tied to the top relevant description.
Select topic bound to the Ontology node: Once the Ontology node is selected, based on the FIG. 2 example binding, the connected Taxonomy node is selected. This is the taxonomy topic bound to Ontology. This is referred to as the Ontology node's topic.
Perform two-hop retrieval of topics (Taxonomy): The parent and grandparent taxonomy nodes (topics) of Ontology node's topic are retrieved. It should be emphasized that the technique doesn't restrict the selection to just 2-hops. It could be n-hops with any combination of children nodes underneath the n-hop nodes. In this example, the parent and grandparent nodes become the recommended topics.
Select bound Ontology nodes from topics: The Ontology nodes associated with the parent and grandparent taxonomy topics are selected.
Select source docs referenced by Ontology nodes: The Ontology nodes are the ones that contain references to the source document or have source documents embedded in them as was shown in 511 of FIG. 2

After execution of 504, the system produces recommended topics and the recommended source documents to the user. The user can use the topics to generate questions or ask an LLM to generate the questions and use the source documents as context reference. The steps in 504 complete the feedback loop that the system uses to continually guide the conversation based on relevance of the responses.

The described embodiments are directed to a knowledge-driven conversation recommendation system. It relies on a technique that utilizes knowledge graphs, taxonomies, or ontologies to facilitate intelligent and contextually relevant conversations. Besides retrieving organized forms of knowledge, the technique also introduces unique ways to suggest new subjects by navigating both ontology and taxonomy graphs seamlessly based on the current content of the conversation.

During the guided conversation the confidentiality of the information plays a key role. Since the user is conversing with an external public LLM, the information in the form of a query or a contextual referenced document may contain sensitive keywords that cannot be disclosed to a public LLMs such as OpenAI chatGPT or Google PaLM.

A naive approach would be to redact sensitive keywords from the document, but this would lead to a public LLM losing context. To avoid a coarse grained approach of simply redacting data, the system introduces three major novel techniques that forms the backbone of its contextualized obfuscation (redaction).

### 1. Term Normalization in Conjunction With Name Anonymizer

Problem: The “Name Anonymizer” referred to a software tool that creates fake names or placeholders using the original name's type or label, like “PERSON”. Every time one uses this tool, it gives a different fake name. However, when you have similar names in a document, the tool may replace them with very different fake names, which can be an issue when sending to an LLM.

Example: Assume two keywords are identified in a document. For example, Intel Corporation and Intel Corp. To a human these two names are very similar. However, when the “Name Anonymizer” is used it would generate two very different names such as Williams Jenson Corp and Harry Tilling Corp. A naive approach would be to replace the original names with Williams Jenson Corp and Harry Tilling Corp in the document and send the document of the LLM. The LLM would see these two keywords as dissimilar and respond with an answer that does not take into context that these two names are very similar in the original document. This naive technique could impact the quality of a LLM's response

Solution: A novel technique is introduced where similarity match is used to perform term normalization. In the previous example, Intel Corporation and Intel Corp would be clustered in the same group of names since they are contextually similar when keywords are initially extracted from the original document. Only one name is selected from the group and its corresponding label is sent to the “Name Anonymizer” to generate a fake name. Now the fake name is assigned to all original names that belong to the same group. So Intel Corporation and Intel Corp both will map to the same fake name such as Williams Jenson Corp. When the LLM receives the obfuscated document, it won't get confused and since it sees the same name. The similarity matching is accelerated by the use of specialized hardware.

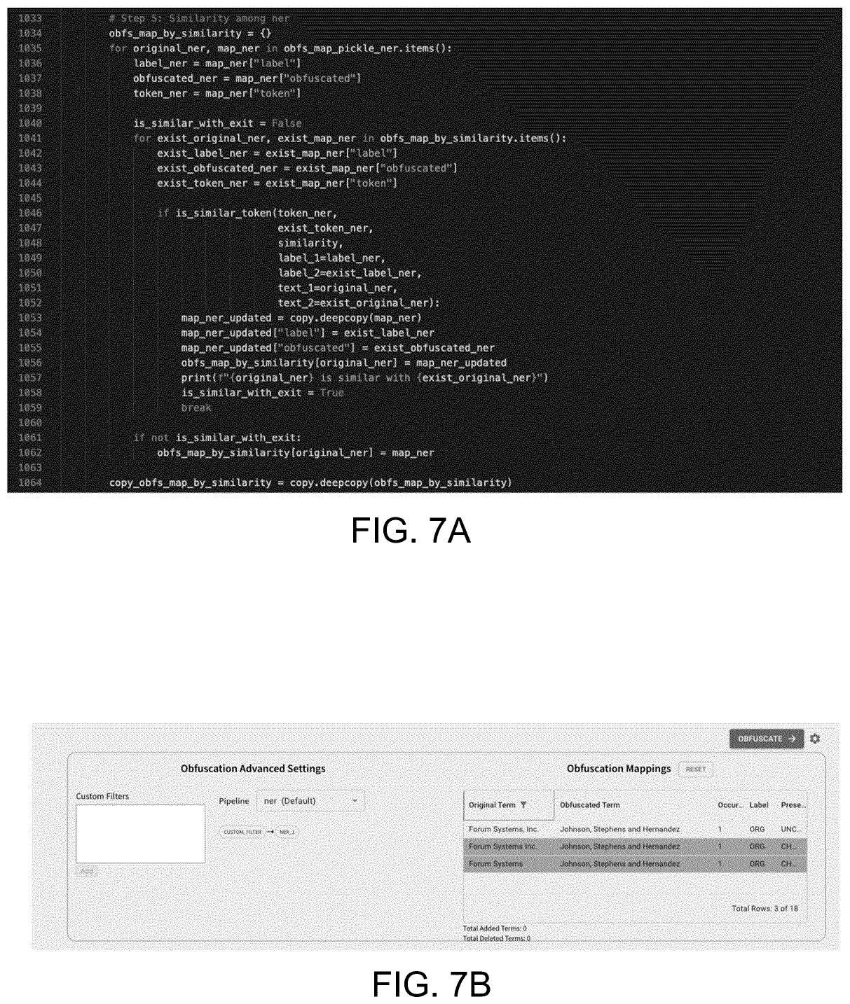

The example code shown in FIG. 7A, along with an example display shown in FIG. 7B, provides an illustrative implementation of this technique. This example code of FIG. 7A is an actual implementation where similar terms or keywords that are extracted from a document are grouped together. This example display shown in FIG. 7B provides a real world example where all similar names of a company are mapped to the same fake name, although the names are not exactly the same.

### 2. Label Resolution of Keywords Using Sliding Similarity

Problem: Extracting keywords from a document or a query is a challenge. Extraction techniques such as Named Entity Recognition (NER), Regex are good at identifying most of the keywords and their respective labels but sometimes there are cases that they miss some of the keywords.

Example: Assume two keywords are identified in a document. For example, Intel Corporation and Intel Corp. To a human these two names are very similar and both terms should be extracted by the underlying NLP extraction techniques such as Named Entity Recognition (NER). But there are cases based on how these words appear close to other words, the NER engine may miss one of the keywords.

Intel Corporation based out of California manufacturers all sorts of semiconductors.

### Intel Corp

### Table Summary:

|$100 Billion revenue |
Example Doc #1:

It is quite possible that the NER engine that has been instructed to select corporation names picks up Intel Corporation and not Intel Corp from the above example document. The omission may be due to the issue of Intel Corp having no surrounding words.

Solution: One way to mitigate the missing keyword problem is to introduce an NLP technique, Part-Of-Speech (POS) tagging; this technique extracts all the words of a document and their corresponding labels. The respective labels are part-of-speech categories such as verbs, nouns, pronouns, prepositions etc. Even though all the words of a document have been identified during POS extraction, the system still needs to map the words extracted from the POS process and map to the words closest to the words that were previously extracted during the NER process. Given the Example Document #1, the system using NER may extract the keyword Intel Corporation but may miss “Intel Corp.”

NER Stage Extraction:

| Name | Label |
|---|---|
| Intel Corporation | OR |

POS Stage Extraction:

| Name | Label |
|---|---|
| Intel Corp | PRPN |

The system using novel techniques of similarity match that can take the POS names, and contextually map it to the closest name that appears from the previous extraction stage, in this case NER. The result consolidated obfuscation mapping table would look like this:

Obfuscation Mapping Table:

| Name | Label |
|---|---|
| Intel Corporation | ORG |
| Intel Corp | ORG |

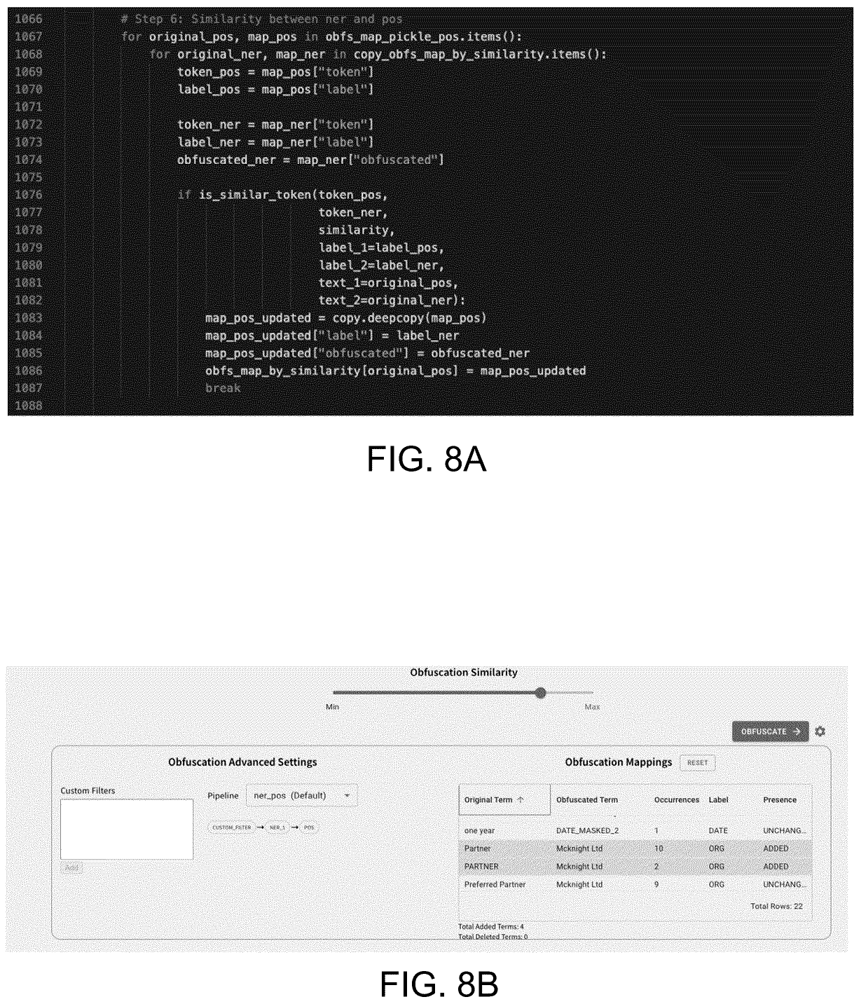

Another novel technique is the Obfuscation slider, that sets the threshold for how loose or how restrictive the system is in aligning POS words to words that were extracted from other NLP stages such as NER and REGEX. The example code in FIG. 8A provides an example implementation of this technique. This example code of FIG. 7A is an actual implementation where words from POS are extracted from a document and are grouped together.

FIG. 8B is an exemplary display that shows a slider with a similarity threshold set to 0.8. The terms highlighted were extracted as part of POS and aligned to the original extracted term “Preferred Partner” in gray color. The slider enabled the system to map the POS keywords to the correct labels by aligning contextually close to Preferred Partner's label.

### 3. Label Resolution of Keywords Using Pipelines

Problem: Keyword extraction from documents or queries can be a daunting task. While extraction methodologies like Named Entity Recognition (NER) and Regular Expressions (Regex) are proficient in pinpointing a majority of the keywords and classifying them with their appropriate labels, they are not foolproof. There exist instances where these methods overlook certain keywords. This oversight can stem from the inherent limitations of each technique or the complexities and nuances present in the text. Thus, relying solely on one or even a combination of a few methods might not ensure a comprehensive extraction, emphasizing the need for a more integrated and robust approach to capture all potential keywords effectively.

Solution: Having a multi-faceted keyword extraction pipeline, consisting of NER, Regex, POS, and Noun Chunks, Knowledge Graphs (Taxonomy+Ontology), acts as a comprehensive net, ensuring that no significant keyword slips through. This holistic approach provides redundancy, guaranteeing that if one method misses a potential keyword, another might catch it. Furthermore, by associating keywords with their labels, the system enables a richer understanding of the context and relationships within the text. In essence, this integrated pipeline not only maximizes keyword capture but also elevates the depth and breadth of insights extracted from the content. The novelty is that one is giving the user the flexibility to organize the pipeline that best fits their needs in terms of accuracy and performance. Second, the introduction of Knowledge Graphs (KG) in the pipeline as an additional component further adds robustness to the keyword extraction process.

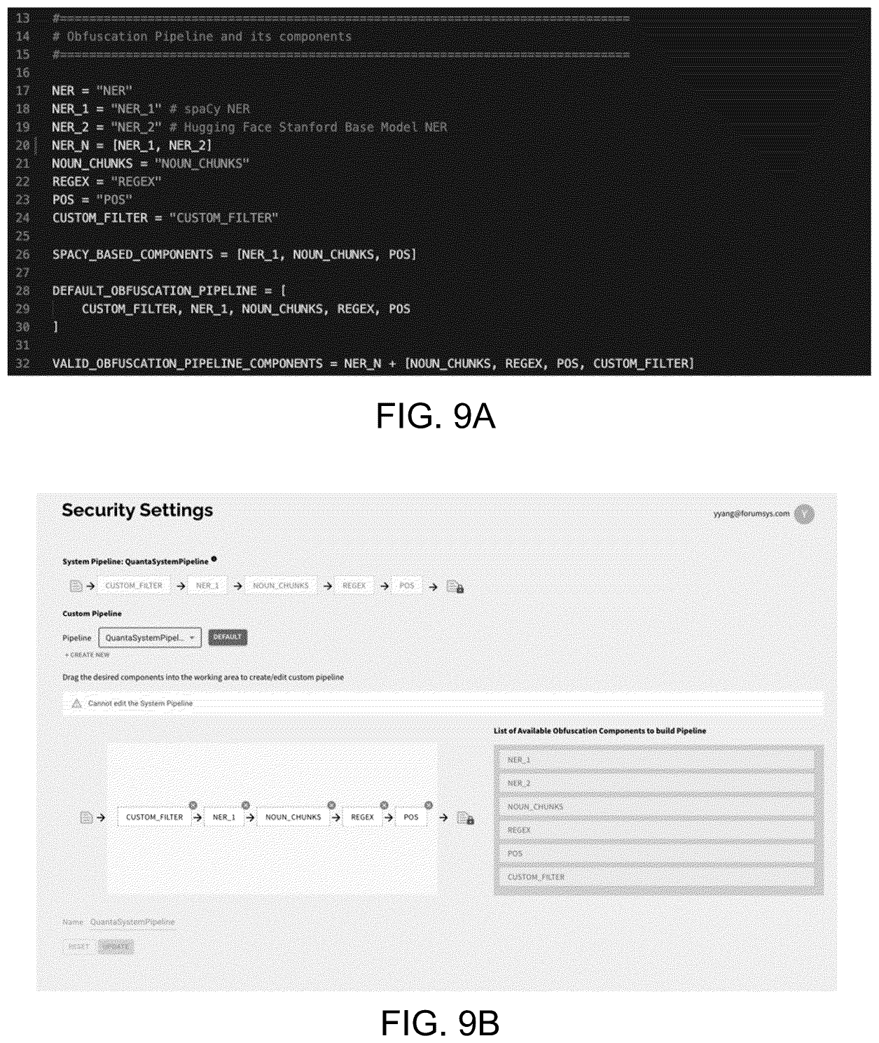

The custom filters in FIG. 8B enable users to add items that they deem sensitive that the obfuscation pipeline (as shown in FIG. 9B) may not have picked. As new terms are added in, the source content and the user-selected terms for obfuscation are added to an LLM or a knowledge graph for training or tuning purposes. This, along with a similarity setting that the user finds acceptable and may obfuscate more or less source content that is used for training/tuning, along with the source data. By adding this Human-in-the-Loop (HITL) to the obfuscation process, the system becomes more intelligent as it trains and fine-tunes on the user verified golden obfuscated records. This feedback loop is a core component of the system and ensures that the burden of custom obfuscation reduces as more enterprise users use the system and add their input to what should be obfuscated. Multiple human reviewers therefore provide redundant and therefore reliable input on protecting sensitive corporate information before sending it to public LLM/GPTs.

The code shown in FIG. 9A provides an example implementation of this pipeline technique. The code of FIG. 9A is an actual implementation where several components of the pipeline are initialized. FIG. 9B shows an example display that demonstrates setting a pipeline for obfuscation or anonymization of data before it is sent to a public LLM/GPT. The pipeline can be organized based on data sensitivity so as to align with corporate data security requirements. As the prompt request or response content comes in, the CUSTOM_FILTERS is followed by NER_1 and then the NOUN_CHUNKS components. The obfuscation or anonymization flow continues till POS as shown in FIG. 9B. The pipeline is fully extensible with additional obfuscation techniques where sensitive data may be encrypted without losing context. For example, a bank account number can be encrypted since the representation of the account number has no impact on an LLMs comprehension about the content, yet the actual account number is highly sensitive from a banking perspective. Symmetric encryption algorithms such as AES-512 as well as asymmetric encryption RSA is used as an example of encrypting sensitive information that an enterprise may not even want to swap with fake information. Contextualized masking is also applied when the information being masked is not deemed relevant to the LLM and does not lead the LLM to lose context.

### Primary Tenants of LLM/GPT Security

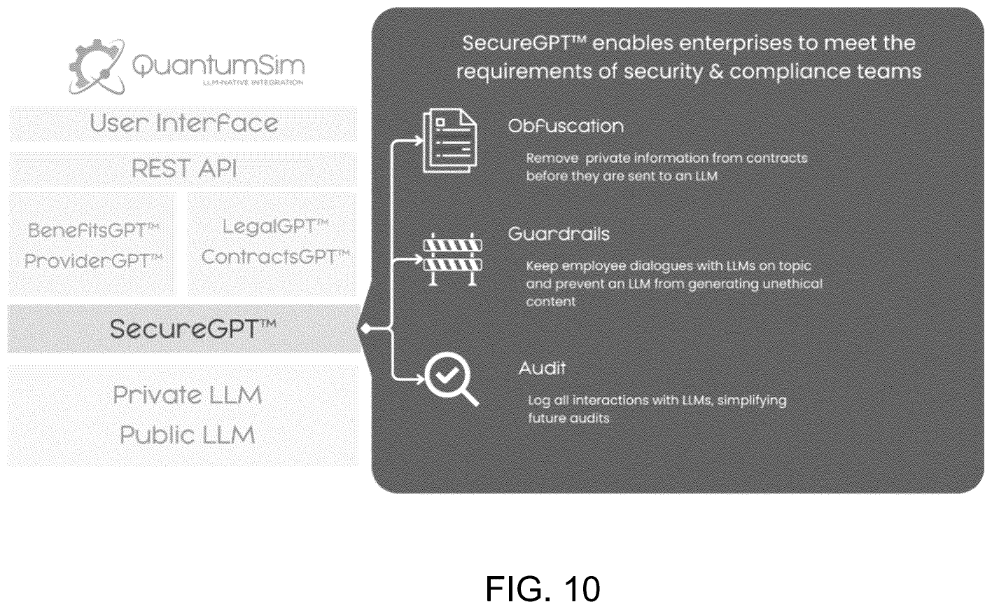

The system of the described embodiments is built on three primary tenants as shown in FIG. 10. The tenants include:
Obfuscation/Anonymization for data protection as described above
Guard Rails to guide the conversation and prevent irrelevant topics
Audit to capture conversations for security compliance

As shown in FIG. 10, an enterprise deployment that includes public and private LLMs/GPTs cannot be securely deployed without providing the stated tenants. As specialized micro-LLMs or larger private LLMs are trained, they need to interact with larger public LLMs for building clusters of Generative AI components that serve corporate requirements. Even if a cooperation turns off access to external LLMs, the need for guardrails and audit still remains while utilizing private LLMs.

While example embodiments have been particularly shown and described, it will be understood by those skilled in the art that various changes in form and details may be made therein without departing from the scope of the embodiments encompassed by the appended claims.

What is claimed is:

1. A knowledge-driven recommendation system, comprising:
a processor; and
a memory with computer code instructions stored thereon, the memory operatively coupled to the processor such that, when executed by the processor, the computer code instructions cause the recommendation system to:
receive a query submitted by a user;
extract a topic from the query;
submit the query and the topic to a custom neural network;
return, from the custom neural network, a collection of taxonomy and ontology pairs;
use the taxonomy and ontology pairs to select information that expands on the query and the topic.

2. The system of claim 1, wherein the topic is extracted from the query by sending the query to an external large language model (LLM) and requesting that the LLM produce a topic based on the query.

3. The system of claim 1, wherein the topic is extracted from the query by extracting nouns from the query and using a public knowledge graph to find a common parent that can be identified as a topic for the nouns.

4. The system of claim 1, wherein the custom neural network is trained on high-quality data that was curated by a human.

5. The system of claim 1, wherein the taxonomy and ontology pairs are the closest matched pairs in an associated knowledge graph.

6. The system of claim 5, wherein the custom neural network retrieves the closest matched pairs when (i) the input taxonomy topic semantically matches closest to a taxonomy topic from the custom neural network, (ii) the input ontology semantically matches closest to an ontology from the custom neural network, and (iii) the taxonomy topic from the custom neural network matches closest to one of the entities in the ontology of the custom neural network.

7. The system of claim 1, wherein the computer code instructions further cause the recommendation system to perform a relevance check of the topic against a taxonomy threshold to determine that sufficient relevance exists.

8. The system of claim 7, wherein if sufficient relevance exists, the computer code instructions further cause the recommendation system to select a most relevant topic in a taxonomy and select an ontology that is bound to the most relevant topic.

9. The system of claim 7, wherein the computer code instructions further cause the recommendation system to take the most relevant topic and retrieve a parent taxonomy topic and grandparent taxonomy topic, and designate the parent taxonomy topic and the grandparent taxonomy topic as recommended topics.

10. The system of claim 1, wherein the computer code instructions further cause the recommendation system to perform a two-hop retrieval of taxonomy topics.

11. A method of recommending new topics and related source documents, comprising:
receiving a query submitted by a user;
extracting a topic from the query;
submitting the query and the topic to a custom neural network;
returning, from the custom neural network, a collection of taxonomy and ontology pairs; and
using the taxonomy and ontology pairs to select information that expands on the query and the topic.

12. The method of claim 11, further extracting the topic from the query by sending the query to an external large language model (LLM) and requesting that the LLM produce a topic based on the query.

13. The method of claim 11, further extracting the topic from the query by extracting nouns from the query and using a public knowledge graph to find a common parent that can be identified as a topic for the nouns.

14. The method of claim 11, further training the custom neural network using on high-quality data that was curated by a human.

15. The method of claim 11, wherein the taxonomy and ontology pairs are the closest matched pairs in the knowledge graph.

16. The method of claim 15, further retrieving, by the custom neural network, the closest matched pairs when (i) the input taxonomy topic semantically matches closest to a taxonomy topic from the custom neural network, (ii) the input ontology semantically matches closest to a ontology from the custom neural network, and (iii) the taxonomy topic from the custom neural network matches closest to one of the entities in the ontology of the custom neural network.

17. The method of claim 11, further performing a relevance check of the topic against a taxonomy threshold to determine that sufficient relevance exists.

18. The method of claim 17, wherein if sufficient relevance exists, selecting a most relevant topic in a taxonomy and select an ontology that is bound to the most relevant topic.

19. The method of claim 17, further taking the most relevant topic and retrieving a parent taxonomy topic and grandparent taxonomy topic, and designating the parent taxonomy topic and the grandparent taxonomy topic as recommended topics.

20. The method of claim 11, further performing a two-hop retrieval of taxonomy topics.
